(19) United States
(12) Patent Application Publication
(10) Pub. No.: US 2025/0224595 A1
(43) Pub. Date: Jul. 10, 2025

(54) OPTICAL IMAGING SYSTEM

(71) Applicant: Samsung Electro-Mechanics Co., Ltd., Suwon-si (KR)

(72) Inventor: Dong Hyuk JANG, Suwon-si (KR)

(73) Assignee: Samsung Electro-Mechanics Co., Ltd., Suwon-si (KR)

(21) Appl. No.: 19/014,926

(22) Filed: Jan. 9, 2025

(30) Foreign Application Priority Data
Jan. 9, 2024 (KR) 10-2024-0003422

(51) Int. Cl. G02B 13/00; G02B 9/64

(52) U.S. Cl. CPC G02B 13/0045; G02B 9/64

(57) ABSTRACT

An optical imaging system includes a first lens, a second lens, a third lens, a fourth lens having a concave object-side surface and a convex image-side surface, a fifth lens, a sixth lens, a seventh lens, and an eighth lens arranged in order from an object-side to an image plane, wherein {TTL/(2*IMG HT)}*Fno<1.000 is satisfied, where TTL is a distance on an optical axis from an object-side surface of the first lens to the image plane, IMG HT is a distance half of a diagonal length of the image plane, and Fno is an F value of the optical imaging system.

### CROSS-REFERENCE TO RELATED APPLICATION(S)

This application claims the benefit under 35 USC 119 (a) of Korean Patent Application No. 10-2024-0003422 filed on Jan. 9, 2024, in the Korean Intellectual Property Office, the entire disclosure of which is incorporated herein by reference in its entirety.

### BACKGROUND

### 1. Field

The present disclosure relates to an optical imaging system.

### 2. Description of the Background

High-performance cameras are adopted in mobile devices. For example, large image sensors with a large number of pixels may be adopted in mobile cameras to implement high-resolution images.

In such cameras, the lens size is generally increased in proportion to the size of the image sensor, but since mobile devices have thickness constraints, it is difficult to make the lens size match the size of the image sensor. Furthermore, even if an increase in the size of the lens is minimized, it may be difficult to avoid designs that harm the appearance, such as camera bumps, due to the slimming of mobile devices.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens, a second lens, a third lens, a fourth lens having a concave object-side surface and a convex image-side surface, a fifth lens, a sixth lens, a seventh lens, and an eighth lens arranged in order from an object-side to an image plane, wherein {TTL/(2*IMG HT)}*Fno<1.000 is satisfied, where TTL is a distance on an optical axis from an object-side surface of the first lens to the image plane, IMG HT is a distance half of a diagonal length of the image plane, and Fno is an F value of the optical imaging system.

The third lens may have positive refractive power.

The sixth lens may have positive refractive power.

The optical imaging system may satisfy 0<v1−(v6+v7)/2<30.00, where v1 is an Abbe number of the first lens, v6 is an Abbe number of the sixth lens, and v7 is an Abbe number of the seventh lens.

The optical imaging system may satisfy 0<f7/f<2.000, where f is a focal length of the optical imaging system, and f7 is a focal length of the seventh lens.

The optical imaging system may satisfy −1.000<f8/f<0, where f is a focal length of the optical imaging system, and f8 is a focal length of the eighth lens.

The third lens may have negative refractive power.

Abbe numbers of the first lens and the fourth lens may be identical to each other.

The seventh lens may have a convex shape on an object-side surface and an image-side surface.

In another general aspect, an optical imaging system includes a first lens, a second lens, a third lens, a fourth lens, a fifth lens, a sixth lens, a seventh lens, and an eighth lens arranged in order from an object side toward an image plane, wherein 0.500≤TTL/(2*IMG HT)<0.750 and 1.000<Fno<1.600 are satisfied, where TTL is a distance on an optical axis from an object-side surface of the first lens to the image plane, IMG HT is a distance half of a diagonal length of the image plane, and Fno is an F value of the optical imaging system.

Abbe numbers of the second lens and the third lens may be identical to each other.

The seventh lens may have positive refractive power and a convex image-side surface.

The third lens may have negative refractive power, and the sixth lens may have positive refractive power.

The optical imaging system may satisfy 1.100≤TTL/f≤1.400, where f is a focal length of the optical imaging system.

Abbe numbers of the first lens and the fourth lens may be identical to each other.

The optical imaging system may satisfy {TTL/(2*IMG HT)}*Fno<1.000.

According to example embodiments of the present disclosure, it may be possible to implement an optical imaging system that is slim and bright compared to the size of an image sensor.

Other features and aspects will be apparent from the following detailed description, the drawings, and the claims.

### BRIEF DESCRIPTION OF DRAWINGS

FIG. 1A is a configuration diagram of an optical imaging system according to a first embodiment of the present disclosure;

FIG. 1B is a graph illustrating aberration characteristics of an optical imaging system according to the first embodiment of the present disclosure;

FIG. 2A is a configuration diagram of an optical imaging system according to a second embodiment of the present disclosure;

FIG. 2B is a graph illustrating aberration characteristics of an optical imaging system according to the second embodiment of the present disclosure;

FIG. 3A is a configuration diagram of an optical imaging system according to a third embodiment of the present disclosure;

FIG. 3B is a graph illustrating aberration characteristics of an optical imaging system according to the third embodiment of the present disclosure;

FIG. 4A is a configuration diagram of an optical imaging system according to a fourth embodiment of the present disclosure;

FIG. 4B is a graph illustrating aberration characteristics of an optical imaging system according to the fourth embodiment of the present disclosure;

FIG. 5A is a configuration diagram of an optical imaging system according to a fifth embodiment of the present disclosure;

FIG. 5B is a graph illustrating aberration characteristics of an optical imaging system according to the fifth embodiment of the present disclosure;

FIG. 6A is a configuration diagram of an optical imaging system according to a sixth embodiment of the present disclosure;

FIG. 6B is a graph illustrating aberration characteristics of an optical imaging system according to the sixth embodiment of the present disclosure;

FIG. 7A is a configuration diagram of an optical imaging system according to a seventh embodiment of the present disclosure;

FIG. 7B is a graph illustrating aberration characteristics of an optical imaging system according to the seventh embodiment of the present disclosure;

FIG. 8A is a configuration diagram of an optical imaging system according to an eighth embodiment of the present disclosure;

FIG. 8B is a graph illustrating aberration characteristics of an optical imaging system according to the eighth embodiment of the present disclosure;

FIG. 9A is a configuration diagram of an optical imaging system according to a ninth embodiment of the present disclosure;

FIG. 9B is a graph illustrating aberration characteristics of an optical imaging system according to the ninth embodiment of the present disclosure;

FIG. 10A is a configuration diagram of an optical imaging system according to a tenth embodiment of the present disclosure;

FIG. 10B is a graph illustrating aberration characteristics of an optical imaging system according to the tenth embodiment of the present disclosure;

FIG. 11A is a configuration diagram of an optical imaging system according to an eleventh embodiment of the present disclosure;

FIG. 11B is a graph illustrating aberration characteristics of an optical imaging system according to the eleventh embodiment of the present disclosure;

FIG. 12A is a configuration diagram of an optical imaging system according to a twelfth embodiment of the present disclosure;

FIG. 12B is a graph illustrating aberration characteristics of an optical imaging system according to the twelfth embodiment of the present disclosure;

FIG. 13A is a configuration diagram of an optical imaging system according to a thirteenth embodiment of the present disclosure; and

FIG. 13B is a graph illustrating aberration characteristics of an optical imaging system according to the thirteenth embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In one or more examples, numerical values for a radius of curvature of a lens, a thickness, a gap or a distance, a focal length, and IMG HT (½ of a diagonal length of an image plane) are all in mm, and the unit of a field of view (FOV) may be degrees. Additionally, a thickness of a lens and a gap between lenses may refer to a thickness and a gap on an optical axis, respectively.

In one or more examples, an object-side may indicate a direction in which an object is disposed, and an image side may indicate, for example, a direction in which an image plane having an image formed thereon is disposed or a direction in which an image sensor is disposed.

In the description related to a shape of a lens in one or more examples, the disclosure that one surface is convex denotes that a paraxial region (e.g., a significantly narrow area near the optical axis) of the corresponding surface is convex, and the disclosure that the one surface is concave denotes that the paraxial region of the corresponding surface is concave. Accordingly, even if one surface of the lens is described as having a convex shape, an edge of the lens may be concave. Similarly, even if one surface of the lens is described as having a concave shape, an edge of the lens may have a convex shape.

An optical imaging system, according to the example embodiments, may form a portion of a camera module mounted on a mobile device. For example, the mobile device may be any type of portable electronic device, such as, but not limited to, a mobile communication terminal, smart phone, or tablet personal computer (PC).

In example embodiments of the present disclosure, an optical imaging system may include eight lenses. For example, the optical imaging system may include a first lens, a second lens, a third lens, a fourth lens, a fifth lens, a sixth lens, a seventh lens, and an eighth lens arranged in order from the object side.

Additionally, the optical imaging system may not be comprised of only a plurality of lenses, but may further include an image sensor that converts incident light into an electrical signal, an infrared cutoff filter that blocks light in an infrared region incident on the image sensor, and an aperture that adjusts an amount of incident light.

In embodiments of the present disclosure, the optical imaging system may include a lens formed of a plastic material. For example, at least some of the first to eighth lenses may be formed of a plastic material, and preferably, all of the first to eighth lenses may be formed of a plastic material.

In example embodiments of the present disclosure, the optical imaging system may include an aspherical lens. For example, at least one of the first to eighth lenses may be an aspherical lens, and in at least one of the first to eighth lenses, at least one of an object-side surface and an upper-side surface is an aspherical surface. The aspherical surface of the lens is expressed by Equation 1.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} \qquad Equation 1$$

In Equation 1, c represents an inverse number of the radius of curvature of the lens, K represents a conical constant, and Y represents a distance from any point on an aspherical surface of the lens to the optical axis. Additionally, constants A to P are aspherical constants from fourth to thirtieth order, and Z (or SAG) is a distance in an optical axis direction between any point on the aspherical surface and a vertex of the corresponding aspherical surface.

In example embodiments of the present disclosure, the optical imaging system may satisfy one or more of the following conditional equations.

$$1.1 \leq TTL / f \leq 1.4 \qquad Conditional Equation 1$$

$$0.5 0 \leq TTL / ( 2 * IMGHT ) < 0.75 \qquad Conditional Equation 2$$

$$\{ TTL / ( 2 * IMGHT ) \} * Fno < 1 \text{.000} \qquad Conditional Equation 3$$

$$1. < Fno < 1.6 \qquad Conditional Equation 4$$

$$0 < v 1 - ( v 6 + v 7 ) / 2 < 30 \text{.00} \qquad Conditional Equation 5$$

$$0 < f 7 / f < 2.0 \; 00 \qquad Conditional Equation 6$$

$$- 1. 00 < f 8 / f < 0 \qquad Conditional Equation 7$$

$$- 0.6 \; 00 < f 1 / f 2 < 0 \qquad Conditional Equation 8$$

$$- 1. 00 < f 1 / f 3 < 0.100 \qquad Conditional Equation 9$$

In Conditional Equation 1, TTL represents a distance on the optical axis from the object side to the image plane of the first lens, and f represents a focal length of the optical imaging system. Conditional Equation 1 is related to a small size feature of the optical imaging system according to example embodiments of the present disclosure.

In Conditional Equation 2, TTL represents a distance on the optical axis from the object side to the image plane of the first lens, and IMGHT represents half of a diagonal length of the image plane (i.e., 2*IMG HT being the diagonal length of the image plane). Conditional Equation 2 is related to a feature in which the size of the optical imaging system, according to example embodiments of the present disclosure, is smaller than the size of the image sensor.

Conditional Equation 3 is related to the size and brightness characteristics of the optical imaging system according to example embodiments of the present disclosure.

Conditional Equation 4 is related to brightness characteristics of an optical imaging system according to example embodiments of the present disclosure.

In Conditional Equation 5, v1 represents an Abbe number of the first lens, v6 represents an Abbe number of the sixth lens, and v7 represents an Abbe number of the seventh lens. Conditional Equation 5 is related to a design condition for improving chromatic aberration correction performance of the optical imaging system according to example embodiments of the present disclosure.

In Conditional Equation 6, f represents a focal length of the optical imaging system, and f7 represents a focal length of the seventh lens. Conditional Equation 6 is related to a condition of the seventh lens for the optical imaging system to have appropriate refractive power according to example embodiments of the present disclosure.

In Conditional Equation 7, f represents a focal length of the optical imaging system, and f8 represents a focal length of the eighth lens. Conditional Equation 7 is related to a condition of the eighth lens for the optical imaging system to have appropriate refractive power according to example embodiments of the present disclosure.

In Conditional Equation 8, f1 represents a focal length of the first lens, and f2 represents a focal length of the second lens. Conditional Equation 8 is related to conditions of the first lens and the second lens for securing aberration correction performance of the optical imaging system according to example embodiments of the present disclosure.

In Conditional Equation 9, f1 represents a focal length of the first lens and f3 represents a focal length of the third lens. Conditional Equation 9 is related to conditions of the first lens and the third lens for securing aberration correction performance of the optical imaging system according to example embodiments of the present disclosure.

Hereinafter, an optical imaging system according to example embodiments of the present disclosure will be described with reference to the accompanying drawings.

### First Embodiment

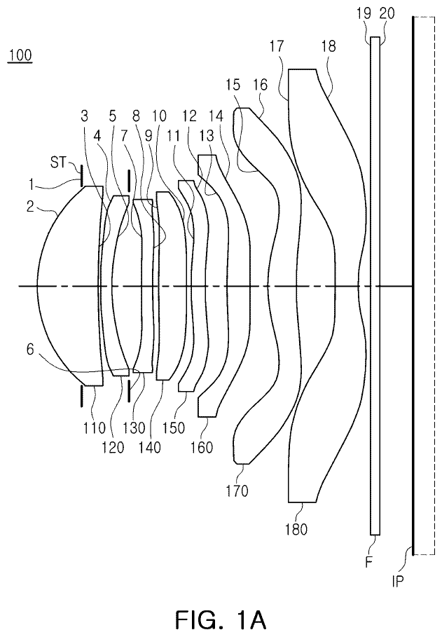

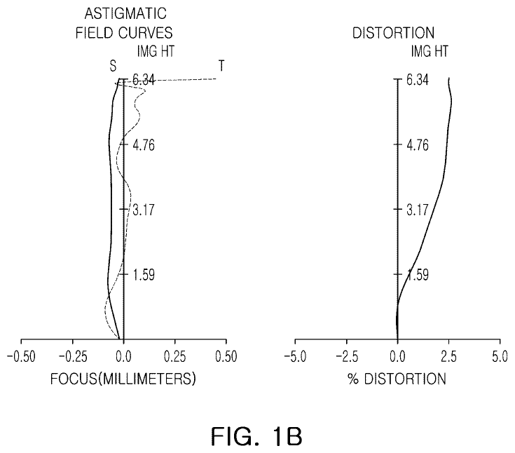

FIG. 1A is a configuration diagram of an optical imaging system according to a first embodiment of the present disclosure. FIG. 1B is a graph illustrating aberration characteristics of an optical imaging system according to the first embodiment of the present disclosure.

According to the first embodiment, an optical imaging system 100 may include a first lens 110, a second lens 120, a third lens 130, a fourth lens 140, a fifth lens 150, a sixth lens 160, a seventh lens 170 and an eighth lens 180 arranged in order from the object side, and may further include an infrared blocking filter F and an image sensor (i.e., an image plane (IP)) disposed on an image side of the eighth lens 180. Additionally, the optical imaging system 100 may further include an aperture ST disposed between an object-side surface and an image-side surface of the first lens 110. Furthermore, the optical imaging system 100 may further include a spacer between the second lens 120 and the third lens 130.

The first lens 110 may have positive refractive power. An object-side surface of the first lens 110 may have a convex shape in the paraxial region, and an image-side surface of the first lens 110 may have a concave shape in the paraxial region. The first lens 110 may be formed of a plastic material. Furthermore, the first lens 110 may be an aspherical lens. For example, the first lens 110 may be a double-sided aspherical lens in which both an object-side surface and an image-side surface thereof are aspherical.

The second lens 120 may have negative refractive power. An object-side surface of the second lens 120 may have a convex shape in the paraxial region, and an image-side surface of the second lens 120 may have a concave shape in the paraxial region. The second lens 120 may be formed of a plastic material. For example, the second lens 120 may be formed of a plastic material having different optical properties (e.g., different refractive index and Abbe number) from the first lens 110. Furthermore, the second lens 120 may be an aspherical lens. For example, the second lens 120 may be a double-sided aspherical lens in which both an object-side surface and an image-side surface thereof are aspherical.

The third lens 130 may have negative refractive power. An object-side surface of the third lens 130 may have a convex shape in the paraxial region, and an image-side surface of the third lens 130 may have a concave shape in the paraxial region. The third lens 130 may be formed of a plastic material. For example, the third lens 130 may be formed of a plastic material having the same optical properties (e.g., the same refractive index and Abbe number) as the second lens 120. Additionally, the third lens 130 may be an aspherical lens. For example, the third lens 130 may be a double-sided aspherical lens in which both an object-side surface and an image-side surface thereof are aspherical.

The fourth lens 140 may have positive refractive power. Both an object-side surface and an image-side surface of the fourth lens 140 may have a convex shape in the paraxial region. The fourth lens 140 may be formed of a plastic material. For example, the fourth lens 140 may be formed of a plastic material having different optical properties (e.g., different refractive index and Abbe number) from the third lens 130. At the same time, the fourth lens 140 may be formed of a plastic material having the same optical properties (e.g., the same refractive index and Abbe number) as the first lens 110. Additionally, the fourth lens 140 may be an aspherical lens. For example, the fourth lens 140 may be a double-sided aspherical lens in which both an object-side surface and an image-side surface thereof are aspherical.

The fifth lens 150 may have negative refractive power. An object-side surface of the fifth lens 150 may have a convex shape in the paraxial region, and an image-side surface of the fifth lens 150 may have a concave shape in the paraxial region. The fifth lens 150 may be formed of a plastic material. For example, the fifth lens 150 may be formed of a plastic material having different optical properties (e.g., different refractive index and Abbe number) from the fourth lens 140. Additionally, the fifth lens 150 may be an aspherical lens. For example, the fifth lens 150 may be a double-sided aspherical lens in which both an object-side surface and an image-side surface thereof are aspherical.

The sixth lens 160 may have positive refractive power. An object-side surface of the sixth lens 160 may have a convex shape in the paraxial region, and an image-side surface of the sixth lens 160 may have a concave shape in the paraxial region. The sixth lens 160 may be formed of a plastic material. For example, the sixth lens 160 may be formed of a plastic material with different optical properties (e.g., different refractive index and Abbe number) from the fifth lens 150. Additionally, the sixth lens 160 may be an aspherical lens. For example, the sixth lens 160 may be a double-sided aspherical lens in which both an object-side surface and an image-side surface thereof are aspherical.

The seventh lens 170 may have a positive refractive power. An object-side surface of the seventh lens 170 may have a convex shape in the paraxial region, and an image-side surface of the seventh lens 170 may have a concave shape in the paraxial region. The seventh lens 170 may be formed of a plastic material. For example, the seventh lens 170 may be formed of a plastic material having different optical properties (e.g., different refractive index and Abbe number) from the sixth lens 160. Additionally, the seventh lens 170 may be an aspherical lens. For example, the seventh lens 170 may be a double-sided aspherical lens in which both an object-side surface and an image-side surface thereof are aspherical.

The eighth lens 180 may have negative refractive power. An object-side surface of the eighth lens 180 may have a convex shape in the paraxial region, and an image-side surface of the eighth lens 180 may have a concave shape in the paraxial region. The eighth lens 180 may be formed of a plastic material. For example, the eighth lens 180 may be formed of a plastic material having different optical properties (e.g., different refractive index and Abbe number) from the seventh lens 170. Additionally, the eighth lens 180 may be an aspherical lens. For example, the eighth lens 180 may be a double-sided aspherical lens in which both an object-side surface and an image-side surface thereof are aspherical.

Table 1 below illustrates optical and physical parameters of the optical imaging system 100 according to the first embodiment of the present disclosure.

TABLE 1

| | Radius of | Thickness/ | Refractive | Abbe |
|---|---|---|---|---|
| Surface | Curvature | Distance | Index | number |
| Object | Infinity | Infinity | | |
| 1 | Infinity | −1.000 | | |
| 2 | 3.069 | 1.379 | 1.544 | 56.0 |
| 3 | 25.359 | 0.050 | | |
| 4 | 9.611 | 0.250 | 1.671 | 19.4 |
| 5 | 5.176 | 0.461 | | |
| 6 | Infinity | 0.198 | | |
| 7 | 16.212 | 0.252 | 1.671 | 19.4 |
| 8 | 10.684 | 0.129 | | |
| 9 | 108.992 | 0.643 | 1.544 | 56.0 |
| 10 | −21.779 | 0.100 | | |
| 11 | 7.661 | 0.310 | 1.671 | 19.4 |
| 12 | 6.659 | 0.501 | | |
| 13 | 18.585 | 0.506 | 1.567 | 37.4 |
| 14 | 19.027 | 0.394 | | |
| 15 | 3.535 | 0.650 | 1.544 | 56.0 |
| 16 | 18.577 | 0.872 | | |
| 17 | 12.091 | 0.500 | 1.535 | 55.7 |
| 18 | 2.266 | 0.295 | | |
| 19 | Infinity | 0.210 | 1.517 | 64.2 |
| 20 | Infinity | 0.740 | | |
| Image | Infinity | | | |

Table 2 below illustrates aspherical data of the optical imaging system 100 according to the first embodiment of the present disclosure.

TABLE 2

| Surface | 2 | 3 | 4 | 5 | 7 | 8 | 9 | 10 |
|---|---|---|---|---|---|---|---|---|
| K | −5.47E−01 | −9.00E+01 | 5.86E+00 | −5.47E+00 | −8.15E+01 | −3.74E+00 | 9.00E+01 | 3.00E+01 |
| A | −4.25E−03 | 1.17E−02 | −5.20E−04 | 1.05E−02 | −1.32E−02 | −8.08E−03 | 2.18E−02 | 8.13E−03 |
| B | 2.05E−02 | −2.61E−02 | −4.93E−03 | −7.14E−02 | −9.14E−03 | −1.69E−02 | −6.02E−02 | 1.99E−02 |
| C | −3.76E−02 | 3.22E−02 | −4.49E−02 | 2.42E−01 | 9.22E−03 | 5.36E−02 | 1.71E−01 | −1.28E−01 |
| D | 4.58E−02 | −2.20E−02 | 1.50E−01 | −5.35E−01 | −4.62E−03 | −1.28E−01 | −3.43E−01 | 2.70E−01 |
| E | −3.81E−02 | 7.40E−03 | −2.33E−01 | 8.10E−01 | −2.54E−03 | 1.92E−01 | 4.64E−01 | −3.34E−01 |
| F | 2.24E−02 | 3.80E−04 | 2.25E−01 | −8.59E−01 | 1.81E−03 | −1.94E−01 | −4.38E−01 | 2.73E−01 |
| G | −9.40E−03 | −1.64E−03 | −1.48E−01 | 6.50E−01 | 6.79E−03 | 1.38E−01 | 2.95E−01 | −1.56E−01 |
| H | 2.87E−03 | 8.43E−04 | 6.85E−02 | −3.54E−01 | −1.18E−02 | −7.06E−02 | −1.44E−01 | 6.39E−02 |
| J | −6.40E−04 | −2.47E−04 | −2.27E−02 | 1.40E−01 | 9.20E−03 | 2.59E−02 | 5.07E−02 | −1.88E−02 |
| L | 1.03E−04 | 4.70E−05 | 5.36E−03 | −3.93E−02 | −4.21E−03 | −6.80E−03 | −1.28E−02 | 3.95E−03 |
| M | −1.18E−05 | −5.95E−06 | −8.81E−04 | 7.72E−03 | 1.21E−03 | 1.24E−03 | 2.25E−03 | −5.76E−04 |
| N | 9.06E−07 | 4.86E−07 | 9.57E−05 | −1.00E−03 | −2.14E−04 | −1.50E−04 | −2.63E−04 | 5.56E−05 |
| O | −4.26E−08 | −2.32E−08 | −6.17E−06 | 7.78E−05 | 2.15E−05 | 1.08E−05 | 1.82E−05 | −3.19E−06 |
| P | 9.30E−10 | 4.89E−10 | 1.79E−07 | −2.72E−06 | −9.39E−07 | −3.47E−07 | −5.70E−07 | 8.20E−08 |
| Surface | 11 | 12 | 13 | 14 | 15 | 16 | 17 | 18 |
| K | −4.77E+00 | −1.02E+01 | 0.00E+00 | 3.55E+01 | −1.12E+01 | −9.90E+01 | 2.21E+00 | −7.67E+00 |
| A | 2.90E−03 | −5.16E−03 | −3.71E−03 | −4.66E−02 | 1.45E−02 | 1.94E−02 | −1.15E−01 | −5.78E−02 |
| B | −3.98E−02 | −1.11E−02 | −2.71E−02 | 1.99E−02 | −1.16E−02 | −4.12E−03 | 4.95E−02 | 2.43E−02 |
| C | 3.11E−02 | −8.66E−03 | 6.31E−02 | −1.57E−02 | 3.54E−03 | −1.62E−03 | −1.84E−02 | −8.11E−03 |
| D | −1.12E−02 | 3.11E−02 | −8.65E−02 | 1.20E−02 | −1.00E−03 | 8.74E−04 | 5.32E−03 | 1.99E−03 |
| E | 4.85E−04 | −3.86E−02 | 7.78E−02 | −6.61E−03 | 1.75E−04 | −1.92E−04 | −1.09E−03 | −3.50E−04 |
| F | −6.33E−04 | 2.94E−02 | −4.85E−02 | 2.45E−03 | 1.15E−06 | 2.45E−05 | 1.58E−04 | 4.44E−05 |
| G | 2.56E−03 | −1.54E−02 | 2.14E−02 | −5.92E−04 | −9.66E−06 | −2.01E−06 | −1.65E−05 | −4.14E−06 |
| H | −2.27E−03 | 5.68E−03 | −6.82E−03 | 8.52E−05 | 2.67E−06 | 1.41E−07 | 1.27E−06 | 2.81E−07 |
| J | 1.07E−03 | −1.50E−03 | 1.56E−03 | −4.80E−06 | −3.91E−07 | −1.36E−08 | −7.09E−08 | −1.41E−08 |
| L | −3.12E−04 | 2.82E−04 | −2.52E−04 | −5.84E−07 | 3.55E−08 | 1.40E−09 | 2.87E−09 | 5.13E−10 |
| M | 5.85E−05 | −3.68E−05 | 2.83E−05 | 1.42E−07 | −2.06E−09 | −9.97E−11 | −8.20E−11 | −1.32E−11 |
| N | −6.91E−06 | 3.16E−06 | −2.08E−06 | −1.26E−08 | 7.45E−11 | 4.26E−12 | 1.56E−12 | 2.26E−13 |
| O | 4.68E−07 | −1.61E−07 | 9.04E−08 | 5.50E−10 | −1.54E−12 | −9.97E−14 | −1.79E−14 | −2.32E−15 |
| P | −1.39E−08 | 3.70E−09 | −1.75E−09 | −9.85E−12 | 1.39E−14 | 9.85E−16 | 9.24E−17 | 1.08E−17 |

### Second Embodiment

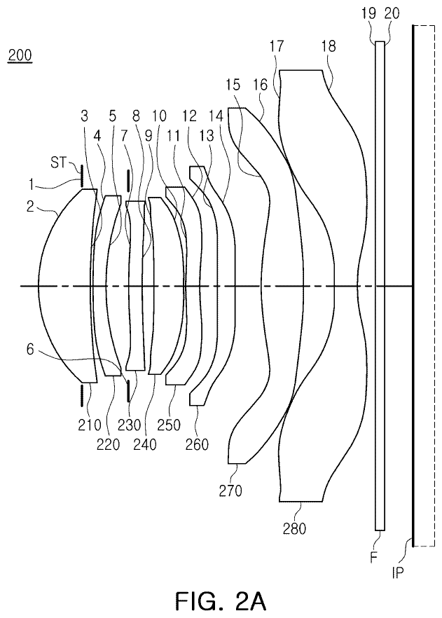

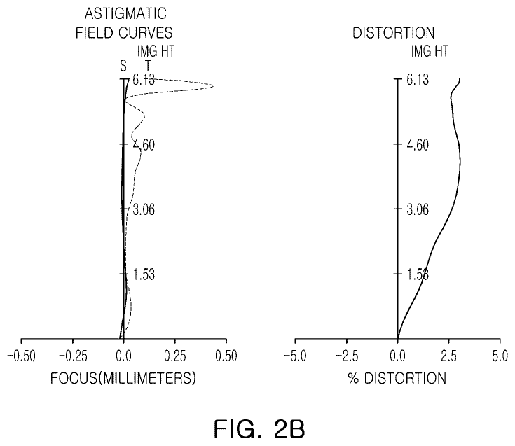

FIG. 2A is a configuration diagram of an optical imaging system according to a second embodiment of the present disclosure. FIG. 2B is a graph illustrating aberration characteristics of an optical imaging system according to the second embodiment of the present disclosure.

According to the second embodiment, an optical imaging system 200 may include a first lens 210, a second lens 220, a third lens 230, a fourth lens 240, a fifth lens 250, a sixth lens 260, a seventh lens 270, and an eighth lens 280 arranged in order from the object side, and may further include an infrared blocking filter F and an image sensor (i.e., an image plane (IP)) disposed on an image side of the eighth lens 280. Additionally, the optical imaging system 200 may further include an aperture ST disposed between an object-side surface and an image-side surface of the first lens 110. Furthermore, the optical imaging system 200 may further include a spacer between the second lens 220 and the third lens 230.

The first lens 210 may have positive refractive power. An object-side surface of the first lens 210 may have a convex shape in the paraxial region, and an image-side surface of the first lens 210 may have a concave shape in the paraxial region. The first lens 210 may be formed of plastic. Furthermore, the first lens 210 may be an aspherical lens. For example, the first lens 210 may be a double-sided aspherical lens in which both an object-side surface and an image-side surface are aspherical.

The second lens 220 may have negative refractive power. An object-side surface of the second lens 220 may have a convex shape in the paraxial region, and an image-side surface of the second lens 220 may have a concave shape in the paraxial region. The second lens 220 may be formed of a plastic material. For example, the second lens 220 may be formed of a plastic material having different optical properties (e.g., different refractive index and Abbe number) from the first lens 210. Additionally, the second lens 220 may be an aspherical lens. For example, the second lens 220 may be a double-sided aspherical lens in which both an object-side surface and an image-side surface thereof are aspherical.

The third lens 230 may have negative refractive power. An object-side surface of the third lens 230 may have a convex shape in the paraxial region, and an image-side surface of the third lens 230 may have a concave shape in the paraxial region. The third lens 230 may be formed of a plastic material. For example, the third lens 230 may be formed of a plastic material having the same optical properties (e.g., the same refractive index and Abbe number) as the second lens 220. Additionally, the third lens 230 may be an aspherical lens. For example, the third lens 230 may be a double-sided aspherical lens in which both an object-side surface and an image-side surface thereof are aspherical.

The fourth lens 240 may have a positive refractive power. An object-side surface of the fourth lens 240 may have a concave shape in the paraxial region, and an image-side surface of the fourth lens 240 may have a convex shape in the paraxial region. The fourth lens 240 may be formed of a plastic material. For example, the fourth lens 240 may be formed of a plastic material having different optical properties (e.g., different refractive index and Abbe number) from the third lens 230. At the same time, the fourth lens 240 may be formed of a plastic material having the same optical properties (e.g., the same refractive index and Abbe number) as the first lens 210. Additionally, the fourth lens 240 may be an aspherical lens. For example, the fourth lens 240 may be a double-sided aspherical lens in which both an object-side surface and an image-side surface thereof are aspherical.

The fifth lens 250 may have negative refractive power. An object-side surface of the fifth lens 250 may have a convex shape in the paraxial region, and an image-side surface of the fifth lens 250 may have a concave shape in the paraxial region. The fifth lens 250 may be formed of a plastic material. For example, the fifth lens 250 may be formed of a plastic material having different optical properties (e.g., different refractive index and Abbe number) from the fourth lens 240. Additionally, the fifth lens 250 may be an aspherical lens. For example, the fifth lens 250 may be a double-sided aspherical lens in which both an object-side surface and an image-side surface thereof are aspherical.

The sixth lens 260 may have negative refractive power. An object-side surface of the sixth lens 260 may have a convex shape in the paraxial region, and an image-side surface of the sixth lens 260 may have a concave shape in the paraxial region. The sixth lens 260 may be formed of a plastic material. For example, the sixth lens 260 may be formed of a plastic material having different optical properties (e.g., different refractive index and Abbe number) from the fifth lens 250. Additionally, the sixth lens 260 may be an aspherical lens. For example, the sixth lens 260 may be a double-sided aspherical lens in which both an object-side surface and an image-side surface thereof are aspherical.

The seventh lens 270 may have positive refractive power. Both an object-side surface and an image-side surface of the seventh lens 270 may have a convex shape in the paraxial region. The seventh lens 270 may be formed of a plastic material. For example, the seventh lens 270 may be formed of a plastic material having different optical properties (e.g., a different refractive index and Abbe number) from the sixth lens 260. Additionally, the seventh lens 270 may be an aspherical lens. For example, the seventh lens 270 may be a double-sided aspherical lens in which both an object-side surface and an image-side surface thereof are aspherical.

The eighth lens 280 may have negative refractive power. An object-side surface of the eighth lens 280 may have a convex shape in the paraxial region, and an image-side surface of the eighth lens 280 may have a concave shape in the paraxial region. The eighth lens 280 may be formed of a plastic material. For example, the eighth lens 280 may be formed of a plastic material having different optical properties (e.g., different refractive index and Abbe number) from the seventh lens 270. Furthermore, the eighth lens 280 may be an aspherical lens. For example, the eighth lens 280 may be a double-sided aspherical lens in which both an object-side surface and an image-side surface thereof are aspherical.

Table 3 below illustrates optical and physical parameters of the optical imaging system 200 according to the second embodiment of the present disclosure.

| [0118] Table 3: | | | | |
|---|---|---|---|---|
| Surface | Radius of | Thickness/ | Refractive | Abbe |
| | Curvature | Distance | Index | number |
| Object | Infinity | Infinity | | |
| 1 | Infinity | -1.000 | | |
| 2 | 3.096 | 1.181 | 1.544 | 56.0 |
| 3 | 23.640 | 0.050 | | |
| 4 | 10.017 | 0.300 | 1.671 | 19.4 |
| 5 | 5.353 | 0.515 | | |
| 6 | Infinity | 0.000 | | |
| 7 | 11.291 | 0.300 | 1.671 | 19.4 |
| 8 | 10.782 | 0.263 | | |
| 9 | -22.003 | 0.673 | 1.544 | 56.0 |
| 10 | -8.689 | 0.050 | | |
| 11 | 11.733 | 0.300 | 1.671 | 19.4 |
| 12 | 7.483 | 0.394 | | |
| 13 | 22.718 | 0.415 | 1.614 | 25.9 |
| 14 | 18.366 | 0.561 | | |
| 15 | 4.472 | 0.957 | 1.544 | 56.0 |
| 16 | -11.243 | 0.700 | | |
| 17 | 16.433 | 0.500 | 1.535 | 55.7 |
| 18 | 2.027 | 0.416 | | |
| 19 | Infinity | 0.210 | 1.517 | 64.2 |
| 20 | Infinity | 0.656 | | |
| Image | Infinity | | | |

Table 4 below illustrates aspherical data of the optical imaging system 200 according to the second embodiment of the present disclosure.

TABLE 4

| Surface | 2 | 3 | 4 | 5 | 7 | 8 | 9 | 10 |
|---|---|---|---|---|---|---|---|---|
| K | −4.83E−01 | 9.29E+00 | 8.87E+00 | −8.20E+00 | −5.31E+01 | 1.38E+01 | −3.13E+01 | 1.32E+01 |
| A | 5.39E−03 | 7.04E−03 | 3.82E−03 | 3.97E−03 | −9.81E−03 | −4.30E−03 | −2.03E−03 | −9.21E−04 |
| B | −1.26E−02 | −1.95E−02 | −5.15E−02 | −3.66E−02 | 3.64E−03 | −4.80E−02 | 6.81E−03 | −3.53E−02 |
| C | 3.04E−02 | 4.60E−02 | 1.53E−01 | 1.28E−01 | −2.32E−02 | 1.83E−01 | 2.23E−03 | 3.38E−02 |
| D | −4.47E−02 | −6.69E−02 | −2.80E−01 | −2.76E−01 | 4.98E−02 | −4.33E−01 | −5.89E−02 | 4.89E−02 |
| E | 4.43E−02 | 6.39E−02 | 3.44E−01 | 3.98E−01 | −7.04E−02 | 6.72E−01 | 1.60E−01 | −1.70E−01 |
| F | −3.08E−02 | −4.19E−02 | −2.94E−01 | −4.01E−01 | 6.63E−02 | −7.21E−01 | −2.37E−01 | 2.31E−01 |
| G | 1.54E−02 | 1.94E−02 | 1.81E−01 | 2.90E−01 | −4.04E−02 | 5.52E−01 | 2.24E−01 | −1.94E−01 |
| H | −5.57E−03 | −6.41E−03 | −8.04E−02 | −1.52E−01 | 1.45E−02 | −3.06E−01 | −1.44E−01 | 1.11E−01 |
| J | 1.47E−03 | 1.52E−03 | 2.60E−02 | 5.84E−02 | −1.86E−03 | 1.23E−01 | 6.43E−02 | −4.44E−02 |
| L | −2.76E−04 | −2.55E−04 | −6.05E−03 | −1.62E−02 | −8.25E−04 | −3.53E−02 | −1.99E−02 | 1.25E−02 |
| M | 3.64E−05 | 2.96E−05 | 9.84E−04 | 3.16E−03 | 4.79E−04 | 7.06E−03 | 4.20E−03 | −2.41E−03 |
| N | −3.17E−06 | −2.26E−06 | −1.06E−04 | −4.14E−04 | −1.10E−04 | −9.33E−04 | −5.76E−04 | 3.07E−04 |
| O | 1.64E−07 | 1.01E−07 | 6.86E−06 | 3.26E−05 | 1.28E−05 | 7.32E−05 | 4.62E−05 | −2.30E−05 |
| P | −3.80E−09 | −2.04E−09 | −1.99E−07 | −1.17E−06 | −6.13E−07 | −2.57E−06 | −1.65E−06 | 7.73E−07 |

| Surface | 11 | 12 | 13 | 14 | 15 | 16 | 17 | 18 |
|---|---|---|---|---|---|---|---|---|
| K | −9.00E+01 | −1.48E+01 | 0.00E+00 | 3.91E+01 | −1.33E+01 | −9.90E+01 | 7.24E+00 | −7.60E+00 |
| A | −6.08E−03 | 4.29E−03 | −3.24E−02 | −5.63E−02 | −4.01E−03 | −5.38E−03 | −1.39E−01 | −6.08E−02 |
| B | −5.55E−02 | −5.11E−02 | 4.17E−02 | 1.89E−02 | −3.60E−03 | −7.59E−04 | 5.74E−02 | 2.54E−02 |
| C | 5.25E−02 | 8.10E−02 | −7.33E−02 | −1.21E−03 | 3.16E−03 | 2.67E−03 | −1.75E−02 | −7.40E−03 |
| D | −1.67E−02 | −1.16E−01 | 9.92E−02 | −8.91E−03 | −1.95E−03 | −2.25E−03 | 4.20E−03 | 1.57E−03 |
| E | −1.06E−02 | 1.32E−01 | −9.56E−02 | 1.04E−02 | 8.32E−04 | 1.17E−03 | −7.54E−04 | −2.44E−04 |
| F | 1.23E−02 | −1.10E−01 | 6.52E−02 | −6.88E−03 | −32.39E−04 | −3.83E−04 | 9.79E−05 | 2.74E−05 |
| G | −3.29E−03 | 6.50E−02 | −3.18E−02 | 3.05E−03 | 4.54E−05 | 8.18E−05 | −9.15E−06 | −2.23E−06 |
| H | −1.88E−03 | −2.76E−02 | 1.12E−02 | −9.41E−04 | −5.81E−06 | −1.18E−05 | 6.15E−07 | 1.32E−07 |
| J | 2.00E−03 | 8.41E−03 | −2.86E−03 | 2.04E−04 | 5.08E−07 | 1.19E−06 | −2.96E−08 | −5.64E−09 |
| L | −8.39E−04 | −1.83E−03 | 5.22E−04 | −3.09E−05 | −3.06E−08 | −8.25E−08 | 1.01E−09 | 1.73E−10 |
| M | 2.05E−04 | 2.76E−04 | −6.62E−05 | 3.17E−06 | 1.26E−09 | 3.91E−09 | −2.34E−11 | −3.69E−12 |
| N | −3.01E−05 | −2.74E−05 | 5.54E−06 | −2.11E−07 | −3.36E−11 | −1.21E−10 | 3.46E−13 | 5.23E−14 |
| O | 2.49E−06 | 1.62E−06 | −2.75E−07 | 8.17E−09 | 5.33E−13 | 2.19E−12 | −2.87E−15 | −4.41E−16 |
| P | −8.90E−08 | −4.29E−08 | 6.12E−09 | −1.40E−10 | −3.80E−15 | −1.76E−14 | 9.50E−18 | 1.68E−18 |

### Third Embodiment

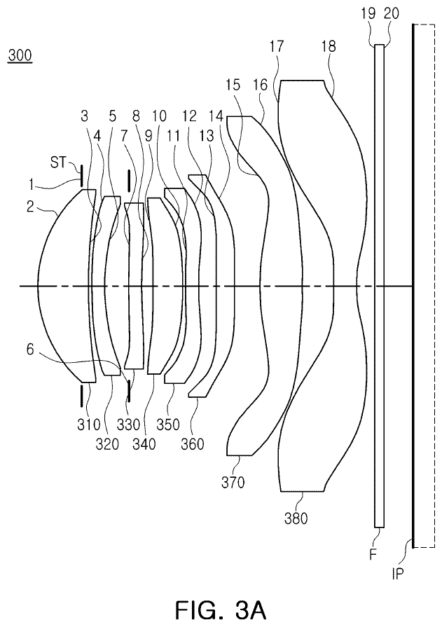

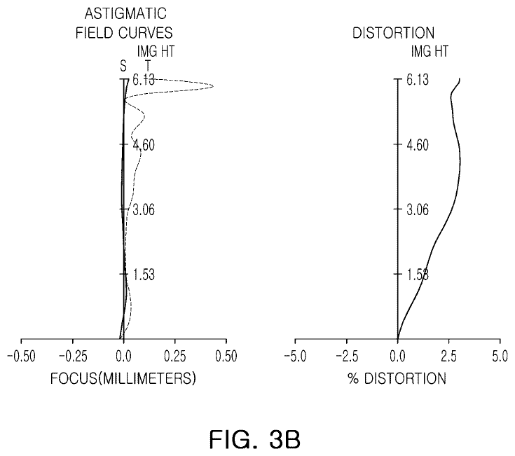

FIG. 3A is a configuration diagram of an optical imaging system according to a third embodiment of the present disclosure. FIG. 3B is a graph illustrating aberration characteristics of an optical imaging system according to the third embodiment of the present disclosure.

According to the third embodiment, an optical imaging system 300 may include a first lens 310, a second lens 320, a third lens 330, a fourth lens 340, a fifth lens 350, a sixth lens 360, a seventh lens 370, and an eighth lens 380 arranged in order from the object side, and may further include an infrared blocking filter F and an image sensor (i.e., an image plane (IP)) disposed on an image side of the eighth lens 380. Additionally, the optical imaging system 300 may further include an aperture ST disposed between an object-side surface and an image-side surface of the first lens 310. Furthermore, the optical imaging system 300 may further include a spacer between the second lens 320 and the third lens 330.

The first lens 310 may have positive refractive power. An object-side surface of the first lens 310 may have a convex shape in the paraxial region, and an image-side surface of the first lens 310 may have a concave shape in the paraxial region. The first lens 310 may be formed of a plastic material. Furthermore, the first lens 310 may be an aspherical lens. For example, the first lens 310 may be a double-sided aspherical lens in which both an object-side surface and an image-side surface thereof are aspherical.

The second lens 320 may have negative refractive power. An object-side surface of the second lens 320 may have a convex shape in the paraxial region, and an image-side surface of the second lens 320 may have a concave shape in the paraxial region. The second lens 320 may be formed of a plastic material. For example, the second lens 320 may be formed of a plastic material having different optical properties (e.g., different refractive index and Abbe number) from the first lens 310. Furthermore, the second lens 320 may be an aspherical lens. For example, the second lens 320 may be a double-sided aspherical lens in which both an object-side surface and an image-side surface thereof are aspherical.

The third lens 330 may have positive refractive power. An object-side surface of the third lens 330 may have a convex shape in the paraxial region, and an image-side surface of the third lens 330 may have a concave shape in the paraxial region. The third lens 330 may be formed of a plastic material. For example, the third lens 330 may be formed of a plastic material having the same optical properties (e.g., the same refractive index and Abbe number) as the second lens 320. Furthermore, the third lens 330 may be an aspherical lens. For example, the third lens 330 may be a double-sided aspherical lens in which both an object-side surface and an image-side surface thereof are aspherical.

The fourth lens 340 may have positive refractive power. An object-side surface of the fourth lens 340 may have a concave shape in the paraxial region, and an image-side surface of the fourth lens 340 may have a convex shape in the paraxial region. The fourth lens 340 may be formed of a plastic material. For example, the fourth lens 340 may be formed of a plastic material having different optical properties (e.g., different refractive index and Abbe number) from the third lens 330. At the same time, the fourth lens 340 may be formed of a plastic material having the same optical properties (e.g., the same refractive index and Abbe number) as the first lens 310. Furthermore, the fourth lens 340 may be an aspherical lens. For example, the fourth lens 340 may be a double-sided aspherical lens in which both an object-side surface and an image-side surface thereof are aspherical.

The fifth lens 350 may have negative refractive power. An object-side surface of the fifth lens 350 may have a convex shape in the paraxial region, and an image-side surface of the fifth lens 350 may have a concave shape in the paraxial region. The fifth lens 350 may be formed of a plastic material. For example, the fifth lens 350 may be formed of a plastic material having different optical properties (e.g., different refractive index and Abbe number) from the fourth lens 340. Additionally, the fifth lens 350 may be an aspherical lens. For example, the fifth lens 350 may be a double-sided aspherical lens in which both an object-side surface and an image-side surface thereof are aspherical.

The sixth lens 360 may have negative refractive power. An object-side surface of the sixth lens 360 may have a convex shape in the paraxial region, and an image-side surface of the sixth lens 360 may have a concave shape in the paraxial region. The sixth lens 360 may be formed of a plastic material. For example, the sixth lens 360 may be formed of a plastic material having different optical properties (e.g., different refractive index and Abbe number) from the fifth lens 350. Additionally, the sixth lens 360 may be an aspherical lens. For example, the sixth lens 360 may be a double-sided aspherical lens in which both an object-side surface and an image-side surface thereof are aspherical.

The seventh lens 370 may have positive refractive power. Both an object-side surface and an image-side surface of the seventh lens 370 may have a convex shape in the paraxial region. The seventh lens 370 may be formed of a plastic material. For example, the seventh lens 370 may be formed of a plastic material having different optical properties (e.g., a different refractive index and Abbe number) from the sixth lens 360. Additionally, the seventh lens 370 may be an aspherical lens. For example, the seventh lens 370 may be a double-sided aspherical lens in which both an object-side surface and an image-side surface thereof are aspherical.

The eighth lens 380 may have negative refractive power. An object-side surface of the eighth lens 380 may have a convex shape in the paraxial region, and an image-side surface of the eighth lens 380 may have a concave shape in the paraxial region. The eighth lens 380 may be formed of a plastic material. For example, the eighth lens 380 may be formed of a plastic material having different optical properties (e.g., different refractive index and Abbe number) from the seventh lens 370. Additionally, the eighth lens 380 may be an aspherical lens. For example, the eighth lens 380 may be a double-sided aspherical lens in which both an object-side surface and an image-side surface thereof are aspherical.

Table 5 below illustrates optical and physical parameters of the optical imaging system 300 according to the third embodiment of the present disclosure.

| [0132] Table 5: | | | | |
|---|---|---|---|---|
| Surface | Radius of | Thickness/ | Refractive | Abbe |
| | Curvature | Distance | Index | number |
| Object | Infinity | Infinity | | |
| 1 | Infinity | -1.000 | | |
| 2 | 3.117 | 1.193 | 1.544 | 56.0 |

Table 6 below illustrates aspherical data of the optical imaging system 300 according to the third embodiment of the present disclosure.

TABLE 6

| Surface | 2 | 3 | 4 | 5 | 7 | 8 | 9 | 10 |
|---|---|---|---|---|---|---|---|---|
| K | −4.96E−01 | 2.66E+00 | 8.82E+00 | −8.21E+00 | −4.99E+01 | 1.31E+01 | −3.45E+01 | 1.33E+01 |
| A | 4.04E−03 | 9.76E−03 | 5.16E−03 | 6.06E−03 | −8.48E−03 | −3.52E−03 | 9.86E−04 | −2.14E−02 |
| B | −8.81E−03 | −2.62E−02 | −5.31E−02 | −4.92E−02 | −3.91E−04 | −4.49E−02 | −2.80E−02 | 8.53E−02 |
| C | 2.59E−02 | 5.30E−02 | 1.44E−01 | 1.60E−01 | −1.63E−02 | 1.56E−01 | 1.71E−01 | −2.88E−01 |
| D | −4.45E−02 | −6.81E−02 | −2.48E−01 | −3.30E−01 | 3.96E−02 | −3.49E−01 | −4.86E−01 | 5.86E−01 |
| E | 5.04E−02 | 5.87E−02 | 2.93E−01 | 4.64E−01 | −5.74E−02 | 5.10E−01 | 8.26E−01 | −7.74E−01 |
| F | −3.94E−02 | −3.52E−02 | −2.45E−01 | −4.61E−01 | 5.35E−02 | −5.10E−01 | −9.32E−01 | 7.06E−01 |
| G | 2.18E−02 | 1.50E−02 | 1.48E−01 | 3.31E−01 | −3.11E−02 | 3.60E−01 | 7.31E−01 | −4.61E−01 |
| H | −8.67E−03 | −4.61E−03 | −6.56E−02 | −1.73E−01 | 9.75E−03 | −1.82E−01 | −4.07E−01 | 2.18E−01 |
| J | 2.48E−03 | 1.02E−03 | 2.11E−02 | 6.60E−02 | −6.58E−05 | 6.57E−02 | 1.62E−01 | −7.52E−02 |
| L | −5.08E−04 | −1.60E−04 | −4.91E−03 | −1.82E−02 | −1.33E−03 | −1.68E−02 | −4.55E−02 | 1.87E−02 |
| M | 7.21E−05 | 1.75E−05 | 7.99E−04 | 3.53E−03 | 5.89E−04 | 2.95E−03 | 8.87E−03 | −3.26E−03 |
| N | −6.76E−06 | −1.25E−06 | −8.63E−05 | −4.57E−04 | −1.28E−04 | −3.36E−04 | −1.13E−03 | 3.78E−04 |
| O | 3.76E−07 | 5.31E−08 | 5.56E−06 | 3.55E−05 | 1.46E−05 | 2.20E−05 | 8.57E−05 | −2.62E−05 |
| P | −9.40E−09 | −1.01E−09 | −1.62E−07 | −1.26E−06 | −7.03E−07 | −6.24E−07 | −2.89E−06 | 8.24E−07 |
| Surface | 11 | 12 | 13 | 14 | 15 | 16 | 17 | 18 |
| K | −7.60E+01 | −1.64E+01 | 0.00E+00 | 3.94E+01 | −1.35E+01 | −9.90E+01 | 5.97E+00 | −7.48E+00 |
| A | −4.94E−03 | 9.63E−03 | −3.71E−02 | −6.01E−02 | −4.28E−03 | −5.23E−03 | −1.38E−01 | −5.95E−02 |
| B | −5.58E−02 | −8.49E−02 | 6.95E−02 | 3.08E−02 | −3.66E−0E | −1.83E−03 | 5.42E−02 | 2.43E−02 |
| C | 5.54E−02 | 1.68E−01 | −1.30E−01 | −1.92E−02 | 3.29E−03 | 3.51E−03 | −1.60E−02 | −6.96E−03 |
| D | −2.33E−02 | −2.54E−01 | 1.70E−01 | 8.08E−03 | −1.95E−03 | −2.64E−03 | 3.95E−03 | 1.48E−03 |
| E | −1.87E−03 | 2.81E−01 | −1.56E−01 | −8.55E−04 | 7.62E−04 | 1.32E−03 | −7.70E−04 | −2.32E−04 |
| F | 3.66E−03 | −2.23E−01 | 1.03E−01 | −1.42E−03 | −1.94E−04 | −4.32E−04 | 1.12E−04 | 2.65E−05 |
| G | 3.54E−03 | 1.28E−01 | −4.88E−02 | 1.10E−03 | 3.11E−05 | 9.35E−05 | −1.18E−05 | −2.19E−06 |
| H | −6.02E−03 | −5.33E−02 | 1.68E−02 | −4.25E−04 | −3.00E−06 | −1.38E−05 | 9.11E−07 | 1.31E−07 |
| J | 3.83E−03 | 1.61E−02 | −4.20E−03 | 1.03E−04 | 1.49E−07 | 1.41E−06 | −5.12E−08 | −5.66E−09 |
| L | −1.42E−03 | −3.46E−03 | 7.53E−04 | −1.65E−05 | 1.46E−10 | −1.01E−07 | 2.07E−09 | 1.75E−10 |
| M | 3.30E−04 | 5.21E−04 | −9.42E−05 | 1.74E−06 | −4.93E−10 | 4.90E−09 | −5.87E−11 | −3.75E−12 |
| N | −4.78E−05 | −5.19E−05 | 7.78E−06 | −1.16E−07 | 2.98E−11 | −1.55E−10 | 1.11E−12 | 5.34E−14 |
| O | 3.95E−06 | 3.08E−06 | −3.82E−07 | 4.42E−09 | −7.99E−13 | 2.89E−12 | −1.25E−14 | −4.52E−16 |
| P | −1.43E−07 | −8.20E−08 | 8.39E−09 | −7.35E−11 | 8.51E−15 | −2.40E−14 | 6.39E−17 | 1.73E−18 |

### Fourth Embodiment

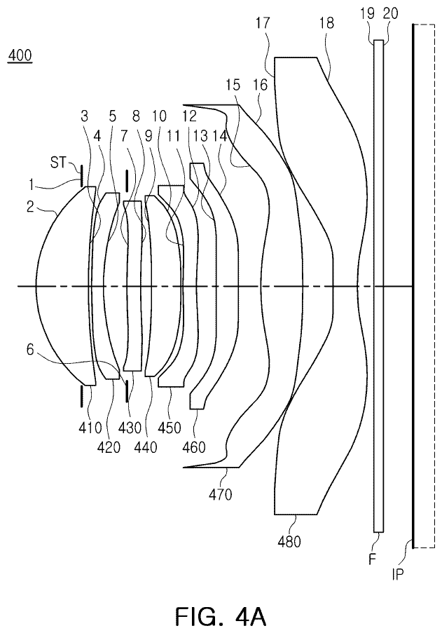

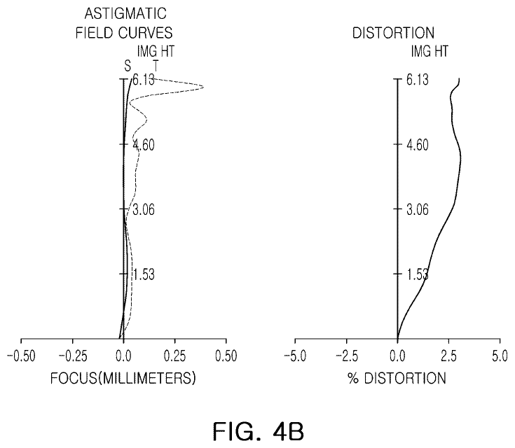

FIG. 4A is a configuration diagram of an optical imaging system according to a fourth embodiment of the present disclosure, and FIG. 4B is a graph illustrating aberration characteristics of an optical imaging system according to the fourth embodiment of the present disclosure.

According to the fourth embodiment, an optical imaging system 400 may include a first lens 410, a second lens 420, a third lens 430, a fourth lens 440, a fifth lens 450, a sixth lens 460, a seventh lens 470, and an eighth lens 480 arranged in order from the object side, and may further include an infrared blocking filter F and an image sensor (i.e., an image plane (IP)) disposed on an image side of the eighth lens 480. Additionally, the optical imaging system 400 may further include an aperture ST disposed between an object-side surface and an image-side surface of the first lens 410. Furthermore, the optical imaging system 400 may further include a spacer between the second lens 420 and the third lens 430.

The first lens 410 may have positive refractive power. An object-side surface of the first lens 410 may have a convex shape in the paraxial region, and an image-side surface of the first lens 410 may have a concave shape in the paraxial region. The first lens 410 may be formed of a plastic material. Additionally, the first lens 410 may be an aspherical lens. For example, the first lens 410 may be a double-sided aspherical lens in which both an object-side surface and an image-side surface thereof are aspherical.

The second lens 420 may have negative refractive power. An object-side surface of the second lens 420 may have a convex shape in the paraxial region, and an image-side surface of the second lens 420 may have a concave shape in the paraxial region. The second lens 420 may be formed of a plastic material. For example, the second lens 420 may be formed of a plastic material having different optical properties (e.g., a different refractive index and Abbe number) from the first lens 410. Additionally, the second lens 420 may be an aspherical lens. For example, the second lens 420 may be a double-sided aspherical lens in which both an object-side surface and an image-side surface thereof are aspherical.

The third lens 430 may have positive refractive power. An object-side surface of the third lens 430 may have a convex shape in the paraxial region, and an image-side surface of the third lens 430 may have a concave shape in a paraxial region. The third lens 430 may be formed of a plastic material. For example, the third lens 430 may be formed of a plastic material having the same optical properties (e.g., the same refractive index and Abbe number) as the second lens 420. Additionally, the third lens 430 may be an aspherical lens. For example, the third lens 430 may be a double-sided aspherical lens in which both an object-side surface and an image-side surface thereof are aspherical.

The fourth lens 440 may have positive refractive power. An object-side surface of the fourth lens 440 may have a concave shape in the paraxial region, and an image-side surface of the fourth lens 440 may have a convex shape in the paraxial region. The fourth lens 440 may be formed of a plastic material. For example, the fourth lens 440 may be formed of a plastic material having different optical properties (e.g., different refractive index and Abbe number) from the third lens 430. At the same time, the fourth lens 440 may be formed of a plastic material having the same optical properties (e.g., the same refractive index and Abbe number) as the first lens 410. Additionally, the fourth lens 440 may be an aspherical lens. For example, the fourth lens 440 may be a double-sided aspherical lens in which both an object-side surface and an image-side surface thereof are aspherical.

The fifth lens 450 may have negative refractive power. An object-side surface of the fifth lens 450 may have a convex shape in the paraxial region, and an image-side surface of the fifth lens 450 may have a concave shape in the paraxial region. The fifth lens 450 may be formed of a plastic material. For example, the fifth lens 450 may be formed of a plastic material having different optical properties (e.g., different refractive index and Abbe number) from the fourth lens 440. Additionally, the fifth lens 450 may be an aspherical lens. For example, the fifth lens 450 may be a double-sided aspherical lens in which both an object-side surface and an image-side surface thereof are aspherical.

The sixth lens 460 may have negative refractive power. An object-side surface of the sixth lens 460 may have a convex shape in the paraxial region, and an image-side surface of the sixth lens 460 may have a concave shape in the paraxial region. The sixth lens 460 may be formed of a plastic material. For example, the sixth lens 460 may be formed of a plastic material having different optical properties (e.g., different refractive index and Abbe number) from the fifth lens 450. Additionally, the sixth lens 460 may be an aspherical lens. For example, the sixth lens 460 may be a double-sided aspherical lens in which both an object-side surface and an image-side surface thereof are aspherical.

The seventh lens 470 may have positive refractive power. Both an object-side surface and an image-side surface of the seventh lens 470 may have a convex shape in the paraxial region. The seventh lens 470 may be formed of a plastic material. For example, the seventh lens 470 may be formed of a plastic material having different optical properties (e.g., a different refractive index and Abbe number) from the sixth lens 460. Additionally, the seventh lens 470 may be an aspherical lens. For example, the seventh lens 470 may be a double-sided aspherical lens in which both an object-side surface and an image-side surface thereof are aspherical.

The eighth lens 480 may have negative refractive power. An object-side surface of the eighth lens 480 may have a convex shape in the paraxial region, and an image-side surface of the eighth lens 480 may have a concave shape in the paraxial region. The eighth lens 480 may be formed of a plastic material. For example, the eighth lens 480 may be formed of a plastic material having different optical properties (e.g., different refractive index and Abbe number) from the seventh lens 470. Additionally, the eighth lens 480 may be an aspherical lens. For example, the eighth lens 480 may be a double-sided aspherical lens in which both an object-side surface and an image-side surface thereof are aspherical.

Table 7 below illustrates optical and physical parameters of the optical imaging system 400 according to the fourth embodiment of the present disclosure.

| [0146] Table 7: | | | | |
|---|---|---|---|---|
| Surface | Radius of | Thickness/ | Refractive | Abbe |
| | Curvature | Distance | Index | number |
| Object | Infinity | Infinity | | |
| 1 | Infinity | -1.000 | | |
| 2 | 3.117 | 1.173 | 1.544 | 56.0 |
| 3 | 25.765 | 0.050 | | |
| 4 | 10.428 | 0.300 | 1.671 | 19.4 |
| 5 | 5.315 | 0.501 | | |
| 6 | Infinity | 0.000 | | |
| 7 | 10.783 | 0.308 | 1.671 | 19.4 |
| 8 | 10.987 | 0.251 | | |
| 9 | -21.416 | 0.656 | 1.544 | 56.0 |
| 10 | -8.944 | 0.050 | | |
| 11 | 13.625 | 0.300 | 1.661 | 20.4 |
| 12 | 8.379 | 0.448 | | |
| 13 | 22.513 | 0.490 | 1.567 | 37.4 |
| 14 | 18.233 | 0.497 | | |
| 15 | 4.171 | 0.950 | 1.544 | 56.0 |
| 16 | -13.415 | 0.679 | | |
| 17 | 16.505 | 0.500 | 1.535 | 55.7 |
| 18 | 2.035 | 0.416 | | |
| 19 | Infinity | 0.210 | 1.517 | 64.2 |
| 20 | Infinity | 0.659 | | |
| Image | Infinity | | | |

Table 8 below illustrates aspherical data of the optical imaging system 400 according to the fourth embodiment of the present disclosure.

TABLE 8

| Surface | 2 | 3 | 4 | 5 | 7 | 8 | 9 | 10 |
|---|---|---|---|---|---|---|---|---|
| K | −4.87E−01 | 3.32E+00 | 9.00E+00 | −8.23E+00 | −5.16E+01 | 1.31E+01 | −2.88E+01 | 1.36E+01 |
| A | 4.47E−03 | 4.76E−03 | 1.33E−03 | −1.28E−03 | −7.67E−03 | −3.18E−03 | −1.52E−02 | −1.46E−02 |
| B | −8.79E−03 | −6.14E−03 | −3.78E−02 | −6.46E−03 | −3.63E−03 | −3.98E−02 | 8.56E−02 | 6.56E−02 |
| C | 2.12E−02 | 1.14E−02 | 1.18E−01 | 2.95E−02 | −1.03E−02 | 1.16E−01 | −2.30E−01 | −2.42E−01 |
| D | −3.09E−02 | −1.44E−02 | −2.27E−01 | −7.71E−02 | 3.28E−02 | −2.18E−01 | 3.58E−01 | 4.98E−01 |
| E | 3.08E−02 | 1.19E−02 | 2.92E−01 | 1.32E−01 | −5.10E−02 | 2.59E−01 | −3.32E−01 | −6.46E−01 |
| F | −2.20E−02 | −6.61E−03 | −2.60E−01 | −1.54E−01 | 4.68E−02 | −1.97E−01 | 1.56E−01 | 5.70E−01 |
| G | 1.16E−02 | 2.46E−03 | 1.65E−01 | 1.28E−01 | −2.44E−02 | 9.09E−02 | 1.09E−02 | −3.57E−01 |
| H | −4.53E−03 | −6.07E−04 | −7.55E−02 | −7.64E−02 | 4.43E−03 | −1.81E−02 | −6.69E−02 | 1.61E−01 |
| J | 1.31E−03 | 9.28E−05 | 2.50E−02 | 3.32E−02 | 2.94E−03 | −5.24E−03 | 4.72E−02 | −5.28E−02 |
| L | −2.76E−04 | −6.87E−06 | −5.92E−03 | −1.04E−02 | −2.52E−03 | 5.01E−03 | −1.84E−02 | 1.24E−02 |
| M | 4.08E−05 | −2.20E−07 | 9.79E−04 | 2.30E−03 | 9.12E−04 | −1.69E−03 | 4.47E−03 | −2.03E−03 |
| N | −4.03E−06 | 9.38E−08 | −1.07E−04 | −3.37E−04 | −1.85E−04 | 3.15E−04 | −6.77E−04 | 2.19E−04 |
| O | 2.37E−07 | −7.63E−09 | 6.96E−06 | 2.96E−05 | 2.06E−05 | −3.18E−05 | 5.86E−05 | −1.40E−05 |
| P | −6.27E−09 | 2.20E−10 | −2.04E−07 | −1.17E−06 | −9.77E−07 | 1.38E−06 | −2.22E−06 | 3.97E−07 |
| Surface | 11 | 12 | 13 | 14 | 15 | 16 | 17 | 18 |
| K | −7.22E+01 | −1.67E+01 | 0.00E+00 | 3.96E+01 | −1.39E+01 | −9.90E+01 | 5.31E+00 | −7.41E+00 |
| A | −2.82E−03 | 1.36E−02 | −2.78E−02 | −5.72E−02 | −4.65E−03 | −5.20E−03 | −1.41E−01 | −6.23E−02 |
| B | −6.42E−02 | −1.10E−01 | 4.00E−02 | 2.37E−02 | −1.12E−03 | 6.01E−04 | 5.84E−02 | 2.66E−02 |
| C | 6.63E−02 | 2.24E−01 | −7.53E−02 | −7.62E−03 | 3.84E−06 | 5.10E−04 | −1.87E−02 | −8.06E−03 |
| D | −2.68E−02 | −3.30E−01 | 1.01E−01 | −5.09E−03 | 1.83E−04 | −8.36E−04 | 5.06E−03 | 1.80E−03 |
| E | −6.22E−03 | 3.50E−01 | −9.52E−02 | 9.47E−03 | −9.11E−05 | 6.38E−04 | −1.05E−03 | −2.95E−04 |
| F | 9.46E−03 | −2.67E−01 | 6.32E−02 | −7.02E−03 | 3.12E−05 | −2.55E−04 | 1.61E−04 | 3.49E−05 |
| G | −1.11E−04 | 1.48E−01 | −3.00E−02 | 3.21E−03 | −9.73E−06 | 6.09E−05 | −1.79E−05 | −2.98E−06 |
| H | −4.42E−03 | −5.99E−02 | 1.03E−02 | −9.89E−04 | 2.18E−06 | −9.46E−06 | 1.44E−06 | 1.84E−07 |
| J | 3.29E−03 | 1.76E−02 | −2.56E−03 | 2.10E−04 | −3.15E−07 | 9.98E−07 | −8.43E−08 | −8.22E−09 |
| L | −1.28E−03 | −3.71E−03 | 4.53E−04 | −3.08E−05 | 2.91E−08 | −7.23E−08 | 3.54E−09 | 2.62E−10 |
| M | 3.06E−04 | 5.47E−04 | −5.59E−05 | 3.05E−06 | −1.72E−09 | 3.55E−09 | −1.04E−10 | −5.79E−12 |
| N | −4.52E−05 | −5.34E−05 | 4.54E−06 | −1.95E−07 | 6.33E−11 | −1.13E−10 | 2.01E−12 | 8.46E−14 |
| O | 3.81E−06 | 3.11E−06 | −2.18E−07 | 7.24E−09 | −1.32E−12 | 2.11E−12 | −2.33E−14 | −7.34E−16 |
| P | −1.41E−07 | −8.15E−08 | 4.67E−09 | −1.1E−10 | 1.19E−14 | −1.75E−14 | 1.21E−16 | 2.86E−18 |

### Fifth Embodiment

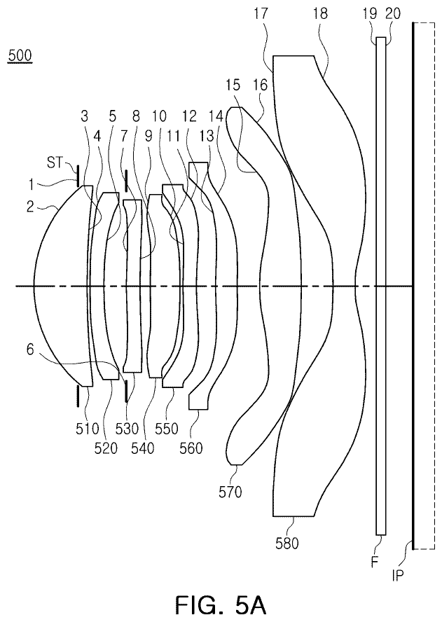

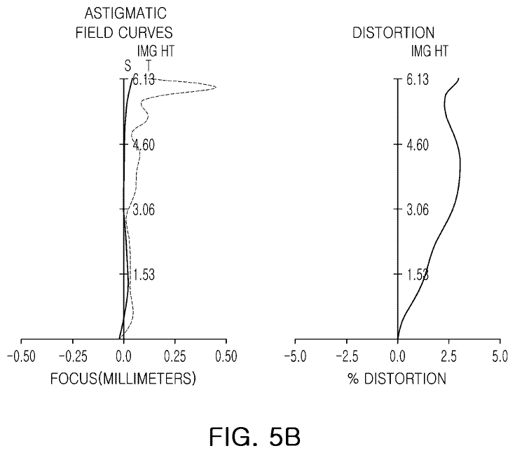

FIG. 5A is a configuration diagram of an optical imaging system according to a fifth embodiment of the present disclosure. FIG. 5B is a graph illustrating aberration characteristics of an optical imaging system according to the fifth embodiment of the present disclosure.

According to the fifth embodiment, an optical imaging system 500 may include a first lens 510, a second lens 520, a third lens 530, a fourth lens 540, a fifth lens 550, a sixth lens 560, a seventh lens 570, and an eighth lens 580 arranged in order from the object side, and may further include an infrared blocking filter F and an image sensor (i.e., an image plane (IP)) disposed on an image side of the eighth lens 580. Furthermore, the optical imaging system 500 may further include an aperture ST disposed between an object-side surface and an image-side surface of the first lens 510. Furthermore, the optical imaging system 500 may further include a spacer between the second lens 520 and the third lens 530.

The first lens 510 may have positive refractive power. An object-side surface of the first lens 510 may have a convex shape in the paraxial region, and an image-side surface of the first lens 510 may have a concave shape in a paraxial region. The first lens 510 may be formed of plastic. Additionally, the first lens 510 may be an aspherical lens. For example, the first lens 510 may be a double-sided aspherical lens in which both an object-side surface and an image-side surface thereof are aspherical.

The second lens 520 may have negative refractive power. An object-side surface of the second lens 520 may have a convex shape in the paraxial region, and an image-side surface of the second lens 520 may have a concave shape in the paraxial region. The second lens 520 may be formed of a plastic material. For example, the second lens 520 may be formed of a plastic material having different optical properties (e.g., different refractive index and Abbe number) from the first lens 510. Additionally, the second lens 520 may be an aspherical lens. For example, the second lens 520 may be a double-sided aspherical lens in which both an object-side surface and an image-side surface thereof are aspherical.

The third lens 530 may have negative refractive power. An object-side surface of the third lens 530 may have a convex shape in the paraxial region, and an image-side surface of the third lens 530 may have a concave shape in the paraxial region. The third lens 530 may be formed of a plastic material. For example, the third lens 530 may be formed of a plastic material having the same optical properties (e.g., the same refractive index and Abbe number) as the second lens 520. Additionally, the third lens 530 may be an aspherical lens. For example, the third lens 530 may be a double-sided aspherical lens in which both an object-side surface and an image-side surface thereof are aspherical.

The fourth lens 540 may have positive refractive power. An object-side surface of the fourth lens 540 may have a concave shape in the paraxial region, and an image-side surface of the fourth lens 540 may have a convex shape in the paraxial region. The fourth lens 540 may be formed of a plastic material. For example, the fourth lens 540 may be formed of a plastic material having different optical properties (e.g., different refractive index and Abbe number) from the third lens 530. At the same time, the fourth lens 540 may be formed of a plastic material having the same optical properties (e.g., the same refractive index and Abbe number) as the first lens 510. Additionally, the fourth lens 540 may be an aspherical lens. For example, the fourth lens 540 may be a double-sided aspherical lens in which both an object-side surface and an image-side surface thereof aspherical.

The fifth lens 550 may have negative refractive power. An object-side surface of the fifth lens 550 may have a convex shape in the paraxial region, and an image-side surface of the fifth lens 550 may have a concave shape in the paraxial region. The fifth lens 550 may be formed of a plastic material. For example, the fifth lens 550 may be formed of a plastic material having different optical properties (e.g., different refractive index and Abbe number) from the fourth lens 540. Additionally, the fifth lens 550 may be an aspherical lens. For example, the fifth lens 550 may be a double-sided aspherical lens in which both an object-side surface and an image-side surface thereof are aspherical.

The sixth lens 560 may have negative refractive power. An object-side surface of the sixth lens 560 may have a convex shape in the paraxial region, and an image-side surface of the sixth lens 560 may have a concave shape in the paraxial region. The sixth lens 560 may be formed of a plastic material. For example, the sixth lens 560 may be formed of a plastic material having different optical properties (e.g., different refractive index and Abbe number) from the fifth lens 550. Additionally, the sixth lens 560 may be an aspherical lens. For example, the sixth lens 560 may be a double-sided aspherical lens in which both an object-side surface and an image-side surface thereof are aspherical.

The seventh lens 570 may have positive refractive power. Both an object-side surface and an image-side surface of the seventh lens 570 may have a convex shape in the paraxial region. The seventh lens 570 may be formed of a plastic material. For example, the seventh lens 570 may be formed of a plastic material having different optical properties (e.g., a different refractive index and Abbe number) from the sixth lens 560. Additionally, the seventh lens 570 may be an aspherical lens. For example, the seventh lens 570 may be a double-sided aspherical lens in which both an object-side surface and an image-side surface thereof are aspherical.

The eighth lens 580 may have negative refractive power. An object-side surface of the eighth lens 580 may have a convex shape in the paraxial region, and an image-side surface of the eighth lens 580 may have a concave shape in the paraxial region. The eighth lens 580 may be formed of a plastic material. For example, the eighth lens 580 may be formed of a plastic material having different optical properties (e.g., different refractive index and Abbe number) from the seventh lens 570. Additionally, the eighth lens 580 may be an aspherical lens. For example, the eighth lens 580 may be a double-sided aspherical lens in which both an object-side surface and an image-side surface thereof are aspherical.

Table 9 below illustrates optical and physical parameters of the optical imaging system 500 according to the fifth embodiment of the present disclosure.

| [0160] Table 9: | | | | |
|---|---|---|---|---|
| Surface | Radius of | Thickness/ | Refractive | Abbe |
| | Curvature | Distance | Index | number |
| Object | Infinity | Infinity | | |
| 1 | Infinity | -1.000 | | |
| 2 | 3.125 | 1.195 | 1.544 | 56.0 |
| 3 | 28.143 | 0.050 | | |
| 4 | 10.893 | 0.300 | 1.671 | 19.4 |
| 5 | 5.380 | 0.511 | | |
| 6 | Infinity | 0.000 | | |
| 7 | 10.817 | 0.300 | 1.671 | 19.4 |
| 8 | 10.566 | 0.246 | | |
| 9 | -23.570 | 0.666 | 1.544 | 56.0 |
| 10 | -8.961 | 0.050 | | |
| 11 | 11.789 | 0.300 | 1.640 | 23.5 |
| 12 | 7.481 | 0.436 | | |
| 13 | 21.466 | 0.469 | 1.567 | 37.4 |
| 14 | 18.254 | 0.511 | | |
| 15 | 4.200 | 0.931 | 1.544 | 56.0 |
| 16 | -13.264 | 0.691 | | |
| 17 | 16.717 | 0.500 | 1.535 | 55.7 |
| 18 | 2.036 | 0.463 | | |
| 19 | Infinity | 0.210 | 1.517 | 64.2 |
| 20 | Infinity | 0.611 | | |
| Image | Infinity | | | |

Table 10 below illustrates aspherical data of the optical imaging system 500 according to the fifth embodiment of the present disclosure.

TABLE 10

| Surface | 2 | 3 | 4 | 5 | 7 | 8 | 9 | 10 |
|---|---|---|---|---|---|---|---|---|
| K | −4.96E−01 | −7.81E+00 | 8.76E+00 | −8.53E+00 | −5.20E+01 | 1.23E+01 | −6.43E+01 | 1.36E+01 |
| A | 4.24E−03 | 6.47E−03 | 2.52E−03 | −7.02E−04 | −7.04E−03 | −4.74E−03 | −7.98E−03 | −1.15E−02 |
| B | −7.66E−03 | −1.62E−02 | −4.62E−02 | −9.87E−03 | −5.75E−03 | −3.24E−02 | 4.22E−02 | 4.49E−02 |
| C | 1.83E−02 | 3.29E−02 | 1.33E−01 | 3.10E−02 | −7.05E−03 | 9.98E−02 | −8.76E−02 | −1.83E−01 |
| D | −2.65E−02 | −4.04E−02 | −2.34E−01 | −5.46E−02 | 3.12E−02 | −2.05E−01 | 7.59E−02 | 4.09E−01 |
| E | 2.64E−02 | 3.26E−02 | 2.78E−01 | 6.20E−02 | −5.45E−02 | 2.71E−01 | 2.62E−02 | −5.75E−01 |
| F | −1.88E−02 | −1.80E−02 | −2.32E−01 | −4.63E−02 | 5.56E−02 | −2.36E−01 | −1.42E−01 | 5.51E−01 |
| G | 9.82E−03 | 6.98E−03 | 1.40E−01 | 2.25E−02 | −3.45E−02 | 1.36E−01 | 1.73E−01 | −3.75E−01 |
| H | −3.79E−03 | −1.91E−03 | −6.09E−02 | −6.62E−03 | 1.18E−02 | −5.00E−02 | −1.21E−01 | 1.85E−01 |
| J | 1.08E−03 | 3.67E−04 | 1.93E−02 | 8.42E−04 | −6.71E−04 | 9.80E−03 | 5.50E−02 | −6.62E−02 |
| L | −2.21E−04 | −4.84E−05 | −4.39E−03 | 1.22E−04 | −1.27E−03 | 1.25E−04 | −1.69E−02 | 1.70E−02 |
| M | 3.19E−05 | 4.21E−06 | 6.96E−04 | −6.45E−05 | 6.10E−04 | −6.08E−04 | 3.53E−03 | −3.05E−03 |
| N | −3.05E−06 | −2.21E−07 | −7.32E−05 | 9.31E−06 | −1.36E−04 | 1.57E−04 | −4.64E−04 | 3.64E−04 |
| O | 1.74E−07 | 5.75E−09 | 4.58E−06 | −4.07E−07 | 1.58E−05 | −1.82E−05 | 3.59E−05 | −2.59E−05 |
| P | −4.47E−09 | −3.76E−11 | −1.29E−07 | −1.21E−080 | −7.63E−07 | 8.51E−07 | −1.22E−06 | 8.34E−07 |

| Surface | 11 | 12 | 13 | 14 | 15 | 6 | 17 | 18 |
|---|---|---|---|---|---|---|---|---|
| K | −7.84E+01 | −1.57E+01 | 0.00E+00 | 3.94E+01 | −1.36E+01 | −9.90E+01 | 5.68E+00 | −7.60E+00 |
| A | −5.74E−03 | 1.28E−02 | −2.82E−02 | −5.40E−02 | −3.00E−03 | −2.99E−03 | −1.40E−01 | −6.07E−02 |
| B | −5.40E−02 | −1.08E−01 | 4.07E−02 | 1.32E−02 | −3.22E−03 | −1.30E−03 | 5.69E−02 | 2.53E−02 |
| C | 5.30E−02 | 2.31E−01 | −7.98E−02 | 7.82E−03 | 1.38E−03 | 1.57E−03 | −1.77E−02 | −7.37E−03 |
| D | −1.96E−02 | −3.54E−01 | 1.14E−01 | −1.92E−02 | −3.93E−04 | −1.25E−03 | 4.55E−03 | 1.58E−03 |
| E | −7.44E−03 | 3.85E−01 | −1.12E−01 | 1.83E−02 | 7.23E−05 | 7.51E−04 | −9.06E−04 | −2.49E−04 |
| F | 1.02E−02 | −2.98E−01 | 7.71E−02 | −1.11E−02 | −7.69E−07 | −2.77E−04 | 1.33E−04 | 2.86E−05 |
| G | −1.87E−03 | 1.66E−01 | −3.78E−02 | 4.57E−03 | −5.42E−06 | 6.41E−05 | −1.43E−05 | −2.37E−06 |
| H | −2.83E−03 | −6.73E−02 | 1.33E−02 | −1.33E−03 | 1.78E−06 | −9.82E−06 | 1.12E−06 | 1.43E−07 |
| J | 2.49E−03 | 1.97E−02 | −3.38E−03 | 2.72E−04 | −2.91E−07 | 1.03E−06 | −6.38E−08 | −6.23E−09 |
| L | −1.02E−03 | −4.15E−03 | 6.12E−04 | −3.91E−05 | 2.82E−08 | −7.39E−08 | 2.62E−09 | 1.94E−10 |
| M | 2.49E−04 | 6.11E−04 | −7.69E−05 | 3.84E−06 | −1.71E−09 | 3.62E−09 | −7.54E−11 | −4.12E−12 |
| N | −3.70E−05 | −5.95E−05 | 6.37E−06 | −2.45E−07 | 6.40E−11 | −1.15E−10 | 1.44E−12 | 6.03E−14 |
| O | 3.11E−06 | 3.45E−06 | −3.12E−07 | \|9.11E−09 | −1.35E−12 | 2.14E−12 | −1.64E−14 | −5.14E−16 |
| P | −1.13E−07 | −9.03E−08 | 6.84E−09 | −1.50E−10 | 1.24E−14 | −1.77E−14 | 8.45E−17 | 1.97E−18 |

### Sixth Embodiment

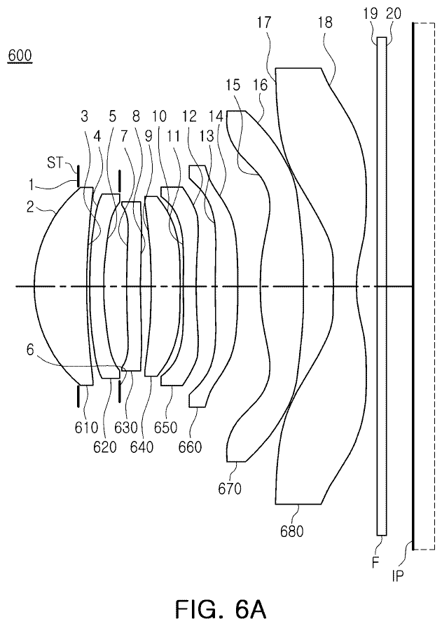

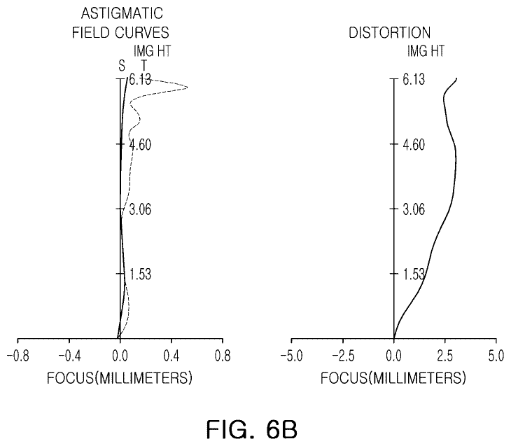

FIG. 6A is a configuration diagram of an optical imaging system according to a sixth embodiment of the present disclosure. FIG. 6B is a graph illustrating aberration characteristics of an optical imaging system according to the sixth embodiment of the present disclosure.

According to the sixth embodiment, an optical imaging system 600 may include a first lens 610, a second lens 620, a third lens 630, a fourth lens 640, a fifth lens 650, a sixth lens 660, a seventh lens 670, and an eighth lens 680 arranged in order from the object side, and may further include an infrared blocking filter F and an image sensor (i.e., an image plane (IP)) disposed on an image side of the eighth lens 680. Additionally, the optical imaging system 600 may further include an aperture ST disposed between an object-side surface and an image-side surface of the first lens 610. Furthermore, the optical imaging system 600 may further include a spacer between the second lens 620 and the third lens 630.

The first lens 610 may have positive refractive power. An object-side surface of the first lens 610 may have a convex shape in the paraxial region, and an image-side surface of the first lens 610 may have a concave shape in the paraxial region. The first lens 610 may be formed of plastic. Furthermore, the first lens 610 may be an aspherical lens. For example, the first lens 610 may be a double-sided aspherical lens in which both an object-side surface and an image-side surface thereof are aspherical.

The second lens 620 may have negative refractive power. An object-side surface of the second lens 620 may have a convex shape in the paraxial region, and the image-side surface of the second lens 620 may have a concave shape in the paraxial region. The second lens 620 may be formed of a plastic material. For example, the second lens 620 may be formed of a plastic material having different optical properties (e.g., different refractive index and Abbe number) from the first lens 610. Additionally, the second lens 620 may be an aspherical lens. For example, the second lens 620 may be a double-sided aspherical lens in which both an object-side surface and an image-side surface thereof are aspherical.

The third lens 630 may have negative refractive power. An object-side surface of the third lens 630 may have a convex shape in the paraxial region, and an image-side surface of the third lens 630 may have a concave shape in a paraxial region. The third lens 630 may be formed of plastic. For example, the third lens 630 may be formed of a plastic material having the same optical properties (e.g., the same refractive index and Abbe number) as the second lens 620. Additionally, the third lens 630 may be an aspherical lens. For example, the third lens 630 may be a double-sided aspherical lens in which both an object-side surface and an image-side surface are aspherical.

The fourth lens 640 may have positive refractive power. An object-side surface of the fourth lens 640 may have a concave shape in a paraxial region, and an image-side surface of the fourth lens 640 may have a convex shape in the paraxial region. The fourth lens 640 may be formed of a plastic material. For example, the fourth lens 640 may be formed of a plastic material with different optical properties (e.g., different refractive index and Abbe number) from those of the third lens 630. At the same time, the fourth lens 640 may be formed of a plastic material having the same optical properties (e.g., the same refractive index and Abbe number) as the first lens 610. Additionally, the fourth lens 640 may be an aspherical lens. For example, the fourth lens 640 may be a double-sided aspherical lens in which both an object-side surface and an image-side surface thereof aspherical.

The fifth lens 650 may have negative refractive power. An object-side surface of the fifth lens 650 may have a convex shape in the paraxial region, and an image-side surface of the fifth lens 650 may have a concave shape in a paraxial region. The fifth lens 650 may be formed of a plastic material. For example, the fifth lens 650 may be formed of a plastic material having different optical properties (e.g., different refractive index and Abbe number) from the fourth lens 640. Additionally, the fifth lens 650 may be an aspherical lens. For example, the fifth lens 650 may be a double-sided aspherical lens in which both an object-side surface and an image-side surface thereof are aspherical.

The sixth lens 660 may have negative refractive power. An object-side surface of the sixth lens 660 may have a convex shape in the paraxial region, and an image-side surface of the sixth lens 660 may have a concave shape in the paraxial region. The sixth lens 660 may be formed of a plastic material. For example, the sixth lens 660 may be formed of a plastic material having different optical properties (e.g., different refractive index and Abbe number) from the fifth lens 650. Additionally, the sixth lens 660 may be an aspherical lens. For example, the sixth lens 660 may be a double-sided aspherical lens in which both an object-side surface and an image-side surface thereof are aspherical.

The seventh lens 670 may have positive refractive power. Both an object-side surface and an image-side surface of the seventh lens 670 may have a convex shape in a paraxial region. The seventh lens 670 may be formed of a plastic material. For example, the seventh lens 670 may be formed of a plastic material having different optical properties (e.g., a different refractive index and Abbe number) from the sixth lens 660. Additionally, the seventh lens 670 may be an aspherical lens. For example, the seventh lens 670 may be a double-sided aspherical lens in which both an object-side surface and an image-side surface thereof are aspherical.

The eighth lens 680 may have negative refractive power. An object-side surface of the eighth lens 680 may have a convex shape in the paraxial region, and an image-side surface of the eighth lens 680 may have a concave shape in the paraxial region. The eighth lens 680 may be formed of a plastic material. For example, the eighth lens 680 may be formed of a plastic material having different optical properties (e.g., different refractive index and Abbe number) from the seventh lens 670. Additionally, the eighth lens 680 may be an aspherical lens. For example, the eighth lens 680 may be a double-sided aspherical lens in which both an object-side surface and an image-side surface thereof are aspherical.

Table 11 below illustrates optical and physical parameters of the optical imaging system 600 according to the sixth embodiment of the present disclosure.

| [0174] Table 11: | | | | |
|---|---|---|---|---|
| Surface | Radius of | Thickness/ | Refractive | Abbe |
| | Curvature | Distance | Index | number |
| Object | Infinity | Infinity | | |
| 1 | Infinity | -1.000 | | |
| 2 | 3.139 | 1.200 | 1.544 | 56.0 |
| 3 | 28.044 | 0.050 | | |
| 4 | 10.900 | 0.300 | 1.671 | 19.4 |
| 5 | 5.403 | 0.414 | | |
| 6 | Infinity | 0.100 | | |
| 7 | 10.705 | 0.300 | 1.671 | 19.4 |
| 8 | 10.511 | 0.241 | | |
| 9 | -24.176 | 0.666 | 1.544 | 56.0 |
| 10 | -9.086 | 0.050 | | |
| 11 | 12.425 | 0.300 | 1.640 | 23.5 |
| 12 | 7.553 | 0.425 | | |
| 13 | 19.857 | 0.485 | 1.567 | 37.4 |
| 14 | 18.283 | 0.502 | | |
| 15 | 4.094 | 0.969 | 1.544 | 56.0 |
| 16 | -14.278 | 0.677 | | |
| 17 | 16.441 | 0.500 | 1.535 | 55.7 |
| 18 | 2.047 | 0.463 | | |
| 19 | Infinity | 0.210 | 1.517 | 64.2 |
| 20 | Infinity | 0.604 | | |
| Image | Infinity | | | |

Table 12 below shows aspherical data of the optical imaging system 600 according to the sixth embodiment of the present disclosure.

TABLE 12

| Surface | 2 | 3 | 4 | 5 | 7 | 8 | 9 | 10 |
|---|---|---|---|---|---|---|---|---|
| K | −4.89E−01 | −4.83E+00 | 8.84E+00 | −8.64E+00 | −5.26E+01 | 1.19E+01 | −6.84E+01 | 1.34E+01 |
| A | 6.63E−03 | 4.51E−03 | 2.76E−03 | −8.01E−04 | −7.32E−03 | −5.43E−03 | −1.45E−02 | −7.39E−03 |
| B | −1.76E−02 | −9.18E−03 | −5.06E−02 | −1.18E−02 | −4.89E−03 | −3.21E−02 | 7.76E−02 | 2.15E−02 |
| C | 4.16E−02 | 1.74E−02 | 1.52E−01 | 4.62E−02 | −7.20E−03 | 1.07E−01 | −1.95E−01 | −1.00E−01 |
| D | −6.14E−02 | −1.86E−02 | −2.78E−01 | −1.08E−01 | 2.98E−02 | −2.30E−01 | 2.77E−01 | 2.33E−01 |
| E | 6.16E−02 | 1.21E−02 | 3.43E−01 | 1.72E−01 | −5.22E−02 | 3.20E−01 | −2.13E−01 | −3.29E−01 |
| F | −4.39E−02 | −4.66E−03 | −2.97E−01 | −1.95E−01 | 5.33E−02 | −3.02E−01 | 3.95E−02 | 3.14E−01 |
| G | 2.27E−02 | 8.20E−04 | 1.85E−01 | 1.59E−01 | −3.25E−02 | 2.00E−01 | 9.04E−02 | −2.11E−01 |
| H | −8.58E−03 | 1.27E−04 | −8.32E−02 | −9.48E−02 | 1.03E−02 | −9.35E−02 | −1.06E−01 | 1.02E−01 |
| J | 2.38E−03 | −1.16E−04 | 2.72E−02 | 4.11E−02 | 1.62E−04 | 3.09E−02 | 6.08E−02 | −3.54E−02 |
| L | −4.77E−04 | 3.28E−05 | −6.36E−03 | −1.28E−02 | −1.61E−03 | −7.10E−03 | −2.18E−02 | 8.77E−03 |
| M | 6.71E−05 | −5.23E−06 | 1.04E−03 | 2.80E−03 | 7.03E−04 | 1.09E−03 | 5.09E−03 | −1.51E−03 |
| N | −6.28E−06 | 4.99E−07 | −1.13E−04 | −4.07E−04 | −1.53E−04 | −1.03E−04 | −7.53E−04 | 1.71E−04 |
| O | 3.51E−07 | −2.66E−08 | 7.25E−06 | 3.51E−05 | 1.75E−05 | 5.07E−06 | 6.43E−05 | −1.14E−05 |
| P | −8.82E−09 | 6.10E−10 | −2.10E−07 | −1.37E−06 | −8.43E−07 | −7.95E−08 | −2.42E−06 | 3.43E−07 |
| Surface | 11 | 12 | 13 | 14 | 15 | 16 | 17 | 18 |
| K | −7.77E+01 | −1.57E+01 | 0.00E+00 | 3.93E+01 | −1.37E+01 | −9.90E+01 | 5.73E+00 | −7.29E+00 |
| A | −6.39E−03 | 1.39E−02 | −2.77E−02 | −5.40E−02 | −2.32E−03 | −3.32E−03 | −1.39E−01 | −6.32E−02 |
| B | −5.29E−02 | −1.14E−01 | 4.28E−02 | 1.34E−02 | −3.11E−03 | 1.49E−04 | 5.60E−02 | 2.68E−02 |
| C | 5.23E−02 | 2.41E−01 | −8.72E−02 | 7.62E−03 | 9.94E−04 | −8.22E−05 | −1.73E−02 | −8.06E−03 |
| D | −1.89E−02 | −3.63E−01 | 1.25E−01 | −1.91E−02 | −5.39E−05 | −1.93E−04 | 4.56E−03 | 1.80E−03 |
| E | −9.08E−03 | 3.87E−01 | −1.23E−01 | 1.83E−02 | −1.08E−04 | 3.11E−04 | −9.32E−04 | −2.94E−04 |
| F | 1.24E−02 | −2.95E−01 | 8.43E−02 | −1.10E−02 | 5.92E−05 | −1.53E−04 | 1.40E−04 | 3.49E−05 |
| G | −3.79E−03 | 1.62E−01 | −4.09E−02 | 4.57E−03 | −1.85E−05 | 3.96E−05 | −1.52E−05 | −2.99E−06 |
| H | −1.68E−03 | −6.45E−02 | 1.42E−02 | −1.33E−03 | 3.72E−06 | −6.42E−06 | 1.19E−06 | 1.85E−07 |
| J | 2.00E−03 | 1.87E−02 | −3.57E−03 | 2.73E−04 | −4.89E−07 | 6.93E−07 | −6.76E−08 | −8.28E−09 |
| L | −8.73E−04 | −3.88E−03 | 6.37E−04 | −3.94E−05 | 4.23E−08 | −5.09E−08 | 2.75E−09 | 2.64E−10 |
| M | 2.18E−04 | 5.63E−04 | −7.91E−05 | 3.87E−06 | −2.39E−09 | 2.52E−09 | −7.76E−11 | −5.87E−12 |
| N | −3.28E−05 | −5.42E−05 | 6.46E−06 | −2.47E−07 | 8.53E−11 | −8.07E−11 | 1.45E−12 | 8.62E−14 |
| O | 2.77E−06 | 3.11E−06 | −3.13E−07 | 9.23E−09 | −1.74E−12 | 1.51E−12 | −1.61E−14 | −7.50E−16 |
| P | −1.01E−07 | −8.03E−08 | 6.77E−09 | −1.53E−10 | 1.55E−14 | −1.26E−14 | 7.98E−17 | 2.93E−18 |

### Seventh Embodiment

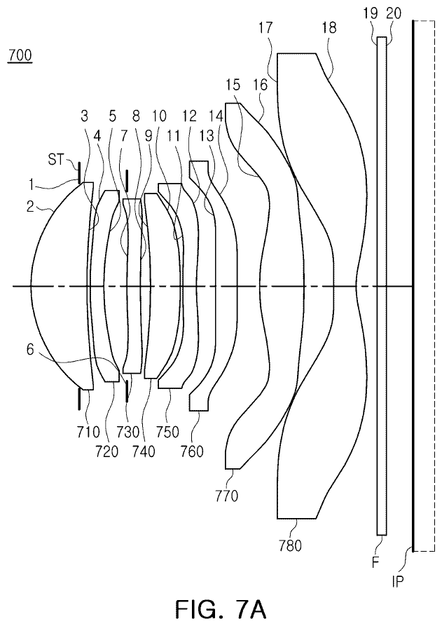

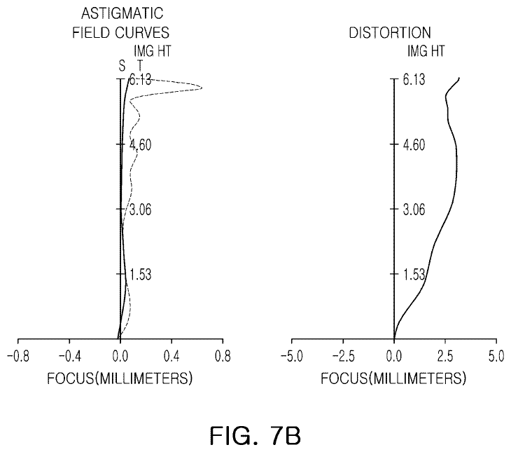

FIG. 7A is a configuration diagram of an optical imaging system according to a seventh embodiment of the present disclosure. FIG. 7B is a graph illustrating aberration characteristics of an optical imaging system according to the seventh embodiment of the present disclosure.

According to the seventh embodiment, an optical imaging system 700 may include a first lens 710, a second lens 720, a third lens 730, a fourth lens 740, a fifth lens 750, a sixth lens 760, a seventh lens 770, and an eighth lens 780 arranged in order from the object side, and may further include an infrared blocking filter F and an image sensor (i.e., an image plane (IP)) disposed on an image side the eighth lens 780. Additionally, the optical imaging system 700 may further include an aperture ST disposed between an object-side surface and an image-side surface of the first lens 710. Furthermore, the optical imaging system 700 may further include a spacer between the second lens 720 and the third lens 730.

The first lens 710 may have positive refractive power. An object-side surface of the first lens 710 may have a convex shape in the paraxial region, and an image-side surface first lens 710 may have a concave shape in the paraxial region. The first lens 710 may be a plastic material. Additionally, the first lens 710 may be an aspherical lens. For example, the first lens 710 may be a double-sided aspherical lens in which both an object-side surface and an image-side surface thereof are aspherical.

The second lens 720 may have negative refractive power. An object-side surface of the second lens 720 may have a convex shape in the paraxial region, and an image-side surface second lens 720 may have a concave shape in the paraxial region. The second lens 720 may be formed of a plastic material. For example, the second lens 720 may be formed of a plastic material having different optical properties (e.g., different refractive index and Abbe number) from the first lens 710. Additionally, the second lens 720 may be an aspherical lens. For example, the second lens 720 may be a double-sided aspherical lens in which both an object-side surface and an image-side surface thereof are aspherical.

The third lens 730 may have positive refractive power. An object-side surface of the third lens 730 may have a convex shape in the paraxial region, and an image-side surface third lens 730 may have a concave shape in the paraxial region. The third lens 730 may be formed of a plastic material. For example, the third lens 730 may be formed of a plastic material having the same optical properties (e.g., the same refractive index and Abbe number) as the second lens 720. Also, the third lens 730 may be an aspherical lens. For example, the third lens 730 may be a double-sided aspherical lens in which both an object-side surface and an image-side surface thereof are aspherical.

The fourth lens 740 may have positive refractive power. An object-side surface of the fourth lens 740 may have a concave shape in the paraxial region, and an image-side surface fourth lens 740 may have a convex shape in the paraxial region. The fourth lens 740 may be formed of a plastic material. For example, the fourth lens 740 may be formed of a plastic material having different optical properties (e.g., different refractive index and Abbe number) from the third lens 730. At the same time, the fourth lens 740 may be formed of a plastic material having the same optical properties (e.g., the same refractive index and Abbe number) as the first lens 710. Additionally, the fourth lens 740 may be an aspherical lens. For example, the fourth lens 740 may be a double-sided aspherical lens in which both an object-side surface and an image-side surface thereof are aspherical.

The fifth lens 750 may have negative refractive power. An object-side surface of the fifth lens 750 may have a convex shape in the paraxial region, and an image-side surface fifth lens 750 may have a concave shape in the paraxial region. The fifth lens 750 may be formed of a plastic material. For example, the fifth lens 750 may be formed of a plastic material having different optical properties (e.g., different refractive index and Abbe number) from the fourth lens 740. Additionally, the fifth lens 750 may be an aspherical lens. For example, the fifth lens 750 may be a double-sided aspherical lens in which both an object-side surface and an image-side surface thereof are aspherical.

The sixth lens 760 may have negative refractive power. An object-side surface of the sixth lens 760 may have a convex shape in the paraxial region, and an image-side surface sixth lens 760 may have a concave shape in the paraxial region. The sixth lens 760 may be formed of a plastic material. For example, the sixth lens 760 may be formed of a plastic material having different optical properties (e.g., different refractive index and Abbe number) from the fifth lens 750. Furthermore, the sixth lens 760 may be an aspherical lens. For example, the sixth lens 760 may be a double-sided aspherical lens in which both an object-side surface and an image-side surface thereof are aspherical.

The seventh lens 770 may have positive refractive power. Both an object-side surface and an image-side surface of the seventh lens 770 may have a convex shape in the paraxial region. The seventh lens 770 may be formed of a plastic material. For example, the seventh lens 770 may be formed of a plastic material having different optical properties (e.g., a different refractive index and Abbe number) from the sixth lens 760. Additionally, the seventh lens 770 may be an aspherical lens. For example, the seventh lens 770 may be a double-sided aspherical lens in which both an object-side surface and an image-side surface thereof are aspherical.

The eighth lens 780 may have negative refractive power. An object-side surface of the eighth lens 780 may have a convex shape in the paraxial region, and an image-side surface eighth lens 780 may have a concave shape in the paraxial region. The eighth lens 780 may be formed of a plastic material. For example, the eighth lens 780 may be formed of a plastic material having different optical properties (e.g., different refractive index and Abbe number) from the seventh lens 770. Also, the eighth lens 780 may be an aspherical lens. For example, the eighth lens 780 may be a double-sided aspherical lens in which both an object-side surface and an image-side surface thereof are aspherical.

Table 13 below shows optical and physical parameters of the optical imaging system 700 according to the seventh embodiment of the present disclosure.

| [0188] Table 13: | | | | |
|---|---|---|---|---|
| Surface | Radius of | Thickness/ | Refractive | Abbe |
| | Curvature | Distance | Index | number |
| Object | Infinity | Infinity | | |
| 1 | Infinity | -1.050 | | |
| 2 | 3.155 | 1.246 | 1.544 | 56.0 |
| 3 | 29.148 | 0.051 | | |
| 4 | 11.029 | 0.301 | 1.671 | 19.4 |
| 5 | 5.410 | 0.506 | | |
| 6 | Infinity | 0.000 | | |
| 7 | 10.587 | 0.300 | 1.671 | 19.4 |
| 8 | 10.489 | 0.238 | | |
| 9 | -24.255 | 0.668 | 1.544 | 56.0 |
| 10 | -9.098 | 0.050 | | |
| 11 | 12.937 | 0.300 | 1.640 | 23.5 |
| 12 | 7.696 | 0.419 | | |
| 13 | 19.478 | 0.499 | 1.567 | 37.4 |
| 14 | 18.311 | 0.491 | | |
| 15 | 4.116 | 0.988 | 1.544 | 56.0 |
| 16 | -13.950 | 0.664 | | |
| 17 | 16.193 | 0.501 | 1.535 | 55.7 |
| 18 | 2.049 | 0.463 | | |
| 19 | Infinity | 0.210 | 1.517 | 64.2 |
| 20 | Infinity | 0.596 | | |
| Image | Infinity | | | |

Table 14 below shows aspherical data of the optical imaging system 700 according to the seventh embodiment of the present disclosure.

TABLE 14

| Surface | 2 | 3 | 4 | 5 | 7 | 8 | 9 | 10 |
|---|---|---|---|---|---|---|---|---|
| K | −4.93E−01 | −5.27E+00 | 9.06E+00 | −8.68E+00 | −5.26E+01 | 1.15E+01 | −6.81E+01 | 1.32E+01 |
| A | 6.69E−03 | 3.61E−03 | 3.06E−03 | −1.02E−03 | −7.30E−03 | −5.58E−03 | −1.95E−02 | −6.70E−03 |
| B | −1.71E−02 | −4.41E−03 | −5.01E−02 | −9.52E−03 | −4.51E−03 | −3.12E−02 | 1.21E−01 | 2.57E−02 |
| C | 3.87E−02 | 5.32E−03 | 1.47E−01 | 3.60E−02 | −7.99E−03 | 1.05E−01 | −3.78E−01 | −1.23E−01 |
| D | −5.46E−02 | −1.02E−03 | −2.64E−01 | −8.11E−02 | 3.14E−02 | −2.26E−01 | 7.43E−01 | 2.88E−01 |
| E | 5.26E−02 | −4.06E−03 | 3.20E−01 | 1.26E−01 | −5.57E−02 | 3.13E−01 | −9.87E−01 | −4.13E−01 |
| F | −3.60E−02 | 5.26E−03 | −2.72E−01 | −1.38E−01 | 5.85E−02 | −2.93E−01 | 9.17E−01 | 4.01E−01 |
| G | 1.79E−02 | −3.41E−03 | 1.66E−01 | 1.10E−01 | −3.79E−02 | 1.91E−01 | −6.11E−01 | −2.77E−01 |
| H | −6.53E−03 | 1.40E−03 | −7.31E−02 | −6.46E−02 | 1.43E−02 | −8.79E−02 | 2.95E−01 | 1.38E−01 |
| J | 1.75E−03 | −3.86E−04 | 2.34E−02 | 2.76E−02 | −1.97E−03 | 2.82E−02 | −1.03E−01 | −4.97E−02 |
| L | −3.38E−04 | 7.31E−05 | −5.38E−03 | −8.55E−03 | −8.10E−04 | −6.17E−03 | 2.61E−02 | 1.28E−02 |
| M | 4.59E−05 | −9.34E−06 | 8.63E−04 | 1.86E−03 | 4.96E−04 | 8.69E−04 | −4.61E−03 | −2.31E−03 |
| N | −4.15E−06 | 7.71E−07 | −9.18E−05 | −2.69E−04 | −1.18E−04 | −6.86E−05 | 5.42E−04 | 2.75E−04 |
| O | 2.24E−07 | −3.71E−08 | 5.81E−06 | 2.33E−05 | 1.40E−05 | 1.89E−06 | −3.81E−05 | −1.94E−05 |
| P | −5.45E−09 | 7.89E−10 | −1.66E−07 | −9.09E−07 | −6.84E−07 | 5.31E−08 | 1.21E−06 | 6.19E−07 |
| Surface | 11 | 12 | 13 | 14 | 15 | 16 | 17 | 18 |
| K | −7.60E+01 | −1.56E+01 | 0.00E+00 | 3.93E+01 | −1.37E+01 | −9.90E+01 | 5.98E+00 | −7.22E+00 |
| A | −6.59E−03 | 1.36E−02 | −2.78E−02 | −5.39E−02 | −2.95E−03 | −3.22E−03 | −1.39E−01 | −6.44E−02 |
| B | −5.24E−02 | −1.19E−01 | 4.19E−02 | 1.41E−02 | −2.06E−03 | −1.76E−04 | 5.50E−02 | 2.74E−02 |
| C | 5.19E−02 | 2.64E−01 | −8.45E−02 | 6.36E−03 | 2.09E−04 | 2.40E−04 | −1.64E−02 | −8.27E−03 |
| D | −1.85E−02 | −4.07E−01 | 1.22E−01 | −1.74E−02 | 3.66E−04 | −3.35E−04 | 4.11E−03 | 1.86E−03 |
| E | −9.57E−03 | 4.40E−01 | −1.20E−01 | 1.66E−02 | −2.74E−04 | 3.37E−04 | −7.98E−04 | −3.05E−04 |
| F | 1.30E−02 | −3.38E−01 | 8.28E−02 | −9.92E−03 | 1.06E−04 | −1.52E−04 | 1.14E−04 | 3.63E−05 |
| G | −4.41E−03 | 1.86E−01 | −4.03E−02 | 4.05E−03 | −2.78E−05 | 3.82E−05 | −1.17E−05 | −3.13E−06 |
| H | −1.27E−03 | −7.46E−02 | 1.41E−02 | −1.16E−03 | 5.03E−06 | −6.10E−06 | 8.61E−07 | 1.94E−07 |
| J | 1.82E−03 | 2.17E−02 | −3.54E−03 | 2.37E−04 | −6.20E−07 | 6.52E−07 | −4.56E−08 | −8.72E−09 |
| L | −8.15E−04 | −4.52E−03 | 6.33E−04 | −3.37E−05 | 5.15E−08 | −4.76E−08 | 1.70E−09 | 2.79E−10 |
| M | 2.06E−04 | 6.57E−04 | −7.86E−05 | 3.28E−06 | −2.93E−09 | 2.35E−09 | −4.35E−11 | −6.21E−12 |
| N | −3.11E−05 | −6.34E−05 | 6.42E−06 | −2.08E−07 | 9.90E−11 | −7.48E−11 | 7.18E−13 | 9.11E−14 |
| O | 2.63E−06 | 3.64E−06 | −3.11E−07 | 7.68E−09 | −1.99E−12 | 1.40E−12 | −6.76E−15 | −7.92E−16 |
| P | −9.64E−08 | −9.42E−08 | 6.73E−09 | −1.26E−10 | 1.76E−14 | −1.16E−14 | 2.69E−17 | 3.09E−18 |

### Eighth Embodiment

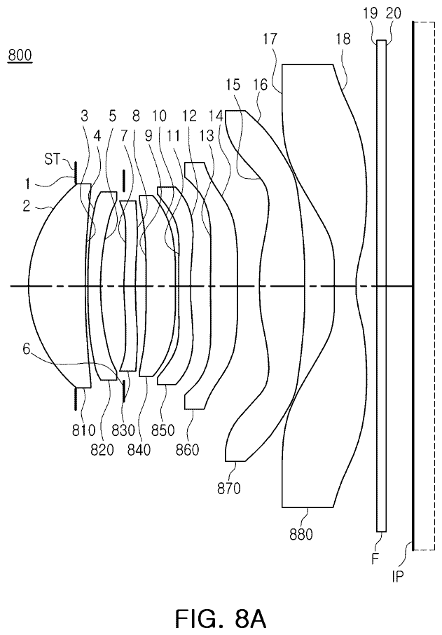

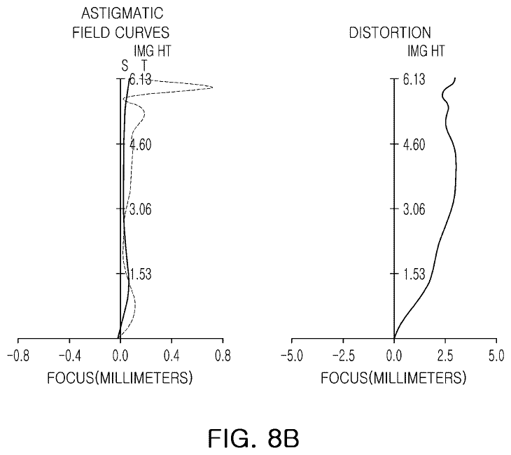

FIG. 8A is a configuration diagram of an optical imaging system according to an eighth embodiment of the present disclosure. FIG. 8B is a graph illustrating aberration characteristics of an optical imaging system according to the eighth embodiment of the present disclosure.

According to the eighth embodiment, an optical imaging system 800 may include a first lens 810, a second lens 820, a third lens 830, a fourth lens 840, a fifth lens 850, a sixth lens 860, a seventh lens 870, and an eighth lens 880 arranged in order from the object side, and may further include an infrared blocking filter F and an image sensor (i.e., an image plane (IP)) disposed on an image side of the eighth lens 880. Additionally, the optical imaging system 800 may further include an aperture ST disposed between an object-side surface and an upper-side surface of the first lens 810. Furthermore, the optical imaging system 800 may further include a spacer between the second lens 820 and the third lens 830.

The first lens 810 may have positive refractive power. An object-side surface of the first lens 810 may have a convex shape in the paraxial region, and an image-side surface of the first lens 810 may have a concave shape in a paraxial region. The first lens 810 may be formed of a plastic material. Additionally, the first lens 810 may be an aspherical lens. For example, the first lens 810 may be a double-sided aspherical lens in which both an object-side surface and an image-side surface are aspherical.

The second lens 820 may have negative refractive power. An object-side surface of the second lens 820 may have a convex shape in the paraxial region, and an image-side surface of the second lens 820 may have a concave shape in the paraxial region. The second lens 820 may be formed of a plastic material. For example, the second lens 820 may be formed of a plastic material having different optical properties (e.g., different refractive index and Abbe number) from the first lens 810. Also, the second lens 820 may be an aspherical lens. For example, the second lens 820 may be a double-sided aspherical lens in which both an object-side surface and an image-side surface thereof are aspherical.

The third lens 830 may have negative refractive power. An object-side surface of the third lens 830 may have a convex shape in the paraxial region, and an image-side surface of the third lens 830 may have a concave shape in the paraxial region. The third lens 830 may be formed of a plastic material. For example, the third lens 830 may be formed of a plastic material having the same optical properties (e.g., the same refractive index and Abbe number) as the second lens 820. Furthermore, the third lens 830 may be an aspherical lens. For example, the third lens 830 may be a double-sided aspherical lens in which both an object-side surface and an image-side surface thereof are aspherical.

The fourth lens 840 may have positive refractive power. An object-side surface of the fourth lens 840 may have a concave shape in the paraxial region, and an image-side surface of the fourth lens 840 may have a convex shape in the paraxial region. The fourth lens 840 may be formed of a plastic material. For example, the fourth lens 840 may be formed of a plastic material having different optical properties (e.g., different refractive index and Abbe number) from the third lens 830. At the same time, the fourth lens 840 may be formed of a plastic material having the same optical properties (e.g., the same refractive index and Abbe number) as the first lens 810. Additionally, the fourth lens 840 may be an aspherical lens. For example, the fourth lens 840 may be a double-sided aspherical lens in which both an object-side surface and an image-side surface thereof are aspherical.

The fifth lens 850 may have negative refractive power. An object-side surface of the fifth lens 850 may have a convex shape in the paraxial region, and an image-side surface of the fifth lens 850 may have a concave shape in the paraxial region. The fifth lens 850 may be formed of a plastic material. For example, the fifth lens 850 may be formed of a plastic material having different optical properties (e.g., different refractive index and Abbe number) from the fourth lens 840. Furthermore, the fifth lens 850 may be an aspherical lens. For example, the fifth lens 850 may be a double-sided aspherical lens in which both the object-side surface and the image-side surface thereof are aspherical.

The sixth lens 860 may have positive refractive power. An object-side surface of the sixth lens 860 may have a convex shape in the paraxial region, and an image-side surface of the sixth lens 860 may have a concave shape in a paraxial region. The sixth lens 860 may be formed of a plastic material. For example, the sixth lens 860 may be formed of a plastic material having different optical properties (e.g., different refractive index and Abbe number) from the fifth lens 850. Additionally, the sixth lens 860 may be an aspherical lens. For example, the sixth lens 860 may be a double-sided aspherical lens in which both an object-side surface and an image-side surface thereof are aspherical.

The seventh lens 870 may have positive refractive power. Both an object-side surface and an image-side surface of the seventh lens 870 may have a convex shape in the paraxial region. The seventh lens 870 may be formed of a plastic material. For example, the seventh lens 870 may be formed of a plastic material having different optical properties (e.g., a different refractive index and Abbe number) from the sixth lens 860. Additionally, the seventh lens 870 may be an aspherical lens. For example, the seventh lens 870 may be a double-sided aspherical lens in which both an object-side surface and an image-side surface thereof are aspherical.

The eighth lens 880 may have negative refractive power. An object-side surface of the eighth lens 880 may have a convex shape in the paraxial region, and an image-side surface of the eighth lens 880 may have a concave shape in the paraxial region. The eighth lens 880 may be formed of a plastic material. For example, the eighth lens 880 may be formed of a plastic material having different optical properties (e.g., different refractive index and Abbe number) from the seventh lens 870. Additionally, the eighth lens 880 may be an aspherical lens. For example, the eighth lens 880 may be a double-sided aspherical lens in which both an object-side surface and an image-side surface are aspherical.

Table 15 below illustrates optical and physical parameters of the optical imaging system 800 according to the eighth embodiment of the present disclosure.

| [0202] Table 15: | | | | |
|---|---|---|---|---|
| Surface | Radius of | Thickness/ | Refractive | Abbe |
| | Curvature | Distance | Index | number |
| Object | Infinity | Infinity | | |
| 1 | Infinity | -1.050 | | |
| 2 | 3.200 | 1.272 | 1.544 | 56.0 |
| 3 | 30.785 | 0.050 | | |
| 4 | 11.115 | 0.285 | 1.671 | 19.4 |
| 5 | 5.495 | 0.527 | | |
| 6 | Infinity | 0.000 | | |
| 7 | 10.518 | 0.243 | 1.671 | 19.4 |
| 8 | 10.404 | 0.240 | | |
| 9 | -24.607 | 0.676 | 1.544 | 56.0 |
| 10 | -9.169 | 0.050 | | |
| 11 | 12.945 | 0.277 | 1.651 | 21.5 |
| 12 | 7.600 | 0.442 | | |
| 13 | 18.627 | 0.594 | 1.567 | 37.4 |
| 14 | 18.471 | 0.480 | | |
| 15 | 4.053 | 1.020 | 1.544 | 56.0 |
| 16 | -14.226 | 0.664 | | |
| 17 | 15.969 | 0.480 | 1.535 | 55.7 |
| 18 | 2.041 | 0.463 | | |
| 19 | Infinity | 0.210 | 1.517 | 64.2 |
| 20 | Infinity | 0.602 | | |
| Image | Infinity | | | |

Table 16 below shows aspherical data of the optical imaging system 800 according to the eighth embodiment of the present disclosure.

TABLE 16

| Surface | 2 | 3 | 4 | 5 | 7 | 8 | 9 | 10 |
|---|---|---|---|---|---|---|---|---|
| K | −4.92E−01 | 5.14E+00 | 8.92E+00 | −8.69E+00 | −5.41E+01 | 1.09E+01 | −4.15E+01 | 1.29E+01 |
| A | 8.07E−03 | −1.28E−03 | 3.98E−04 | −1.27E−03 | −6.01E−03 | −1.22E−03 | −2.10E−02 | 2.55E−03 |
| B | −1.96E−02 | 1.37E−02 | −3.76E−02 | −7.56E−03 | −5.15E−03 | −4.36E−02 | 1.49E−01 | −2.48E−02 |
| C | 3.92E−02 | −2.69E−02 | 1.23E−01 | 3.36E−02 | −8.97E−03 | 1.27E−01 | −5.21E−01 | 4.41E−02 |
| D | −5.06E−02 | 3.50E−02 | −2.30E−01 | −7.63E−02 | 3.42E−02 | −2.56E−01 | 1.11E+00 | −5.87E−02 |
| E | 4.53E−02 | −3.16E−02 | 2.82E−01 | 1.11E−01 | −6.10E−02 | 3.48E−01 | −1.56E+00 | 6.06E−02 |
| F | −2.90E−02 | 2.02E−02 | −2.39E−01 | −1.11E−01 | 6.65E−02 | −3.30E−01 | 1.53E+00 | −4.53E−02 |
| G | 1.35E−02 | −9.21E−03 | 1.43E−01 | 8.00E−02 | −4.68E−02 | 2.21E−01 | −1.07E+00 | 2.24E−02 |
| H | −4.65E−03 | 3.02E−03 | −6.22E−02 | −4.26E−02 | 2.13E−02 | −1.06E−01 | 5.38E−01 | −6.55E−03 |
| J | 1.17E−03 | −7.12E−04 | 1.95E−02 | 1.68E−02 | −5.90E−03 | 3.63E−02 | −1.96E−01 | 6.30E−04 |
| L | −2.14E−04 | 1.19E−04 | −4.39E−03 | −4.85E−03 | 7.39E−04 | −8.78E−03 | 5.11E−02 | 2.89E−04 |
| M | 2.75E−05 | −1.38E−05 | 6.88E−04 | 9.99E−04 | 7.65E−05 | 1.46E−03 | −9.30E−03 | −1.33E−04 |
| N | −2.36E−06 | 1.05E−06 | −7.16E−05 | −1.38E−04 | −4.36E−05 | −1.58E−04 | 1.12E−03 | 2.52E−05 |
| O | 1.21E−07 | −4.70E−08 | 4.43E−06 | 1.16E−05 | 6.30E−06 | 9.94E−06 | −8.04E−05 | −2.44E−06 |
| P | −2.79E−09 | 9.41E−10 | −1.24E−07 | −4.40E−07 | −3.31E−07 | −2.72E−07 | 2.60E−06 | 9.82E−08 |
| Surface | 11 | 12 | 13 | 14 | 15 | 16 | 17 | 18 |
| K | −5.67E+01 | −1.68E+01 | 0.00E+00 | 3.89E+01 | −1.35E+01 | −9.90E+01 | 6.80E+00 | −6.26E+00 |
| A | −1.08E−02 | 7.16E−03 | −2.64E−02 | −4.80E−02 | −1.97E−03 | 1.11E−03 | −1.30E−01 | −6.89E−02 |
| B | −4.31E−02 | −1.13E−01 | 3.06E−02 | −2.73E−03 | −5.60E−03 | −6.30E−03 | 4.34E−02 | 2.92E−02 |
| C | 4.47E−02 | 2.67E−01 | −5.57E−02 | 3.75E−02 | 3.80E−03 | 4.12E−03 | −8.76E−03 | −8.57E−03 |
| D | −1.53E−02 | −4.19E−01 | 7.96E−02 | −5.22E−02 | −1.64E−03 | −1.75E−03 | 1.08E−03 | 1.86E−03 |
| E | −1.12E−02 | 4.54E−01 | −7.90E−02 | 4.26E−02 | 4.76E−04 | 6.53E−04 | −2.54E−05 | −2.99E−04 |
| F | 1.46E−02 | −3.48E−01 | 5.42E−02 | −2.33E−02 | −9.19E−05 | −1.95E−04 | −1.92E−05 | 3.51E−05 |
| G | −5.89E−03 | 1.92E−01 | −2.62E−02 | 8.90E−03 | 9.61E−06 | 4.14E−05 | 4.24E−06 | −3.01E−06 |
| H | −2.35E−04 | −7.67E−02 | 9.08E−03 | −2.42E−03 | −3.52E−08 | −6.07E−06 | −4.93E−07 | 1.87E−07 |
| J | 1.29E−03 | 2.22E−02 | −2.25E−03 | 4.71E−04 | −1.30E−07 | 6.18E−07 | 3.69E−08 | −8.41E−09 |
| L | −6.28E−04 | −4.62E−03 | 3.98E−04 | −6.48E−05 | 1.80E−08 | −4.36E−08 | −1.87E−09 | 2.70E−10 |
| M | 1.60E−04 | 6.71E−04 | −4.86E−05 | 6.15E−06 | −1.25E−09 | 2.10E−09 | 6.41E−11 | −6.04E−12 |
| N | −2.40E−05 | −6.45E−05 | 3.91E−06 | −3.83E−07 | 5.01E−11 | −6.59E−11 | −1.42E−12 | 8.91E−14 |
| O | 1.99E−06 | 3.69E−06 | −1.86E−07 | 1.41E−08 | −1.10E−12 | 1.21E−12 | 1.84E−14 | −7.78E−16 |
| P | −7.11E−08 | −9.50E−08 | 3.94E−09 | −2.31E−10 | 1.02E−14 | −9.93E−15 | −1.06E−16 | 3.05E−18 |

### Ninth Embodiment

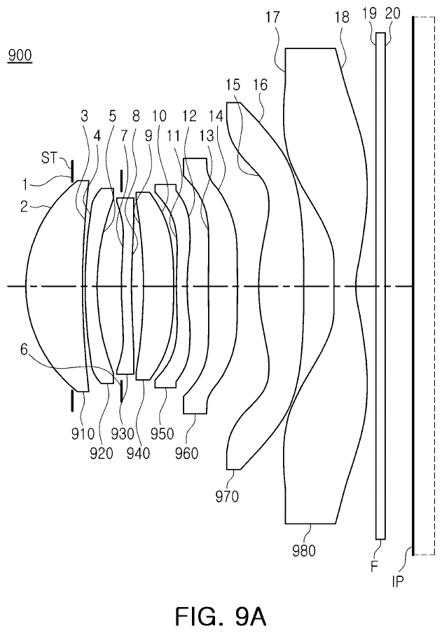

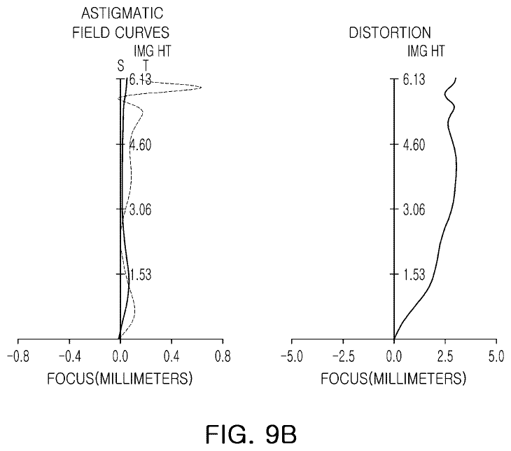

FIG. 9A is a configuration diagram of an optical imaging system according to a ninth embodiment of the present disclosure. FIG. 9B is a graph illustrating aberration characteristics of an optical imaging system according to the ninth embodiment of the present disclosure.

According to the ninth embodiment, an optical imaging system 900 may include a first lens 910, a second lens 920, a third lens 930, a fourth lens 940, a fifth lens 950, a sixth lens 960, a seventh lens 970, and an eighth lens 980 arranged in order from the object side, and may further include an infrared blocking filter F and an image sensor (i.e., an image plane (IP)) disposed on an image side of the eighth lens 980. Additionally, the optical imaging system 900 may further include an aperture ST disposed between an object-side surface and an imaging-side surface of the first lens 910. Furthermore, the optical imaging system 900 may further include a spacer between the second lens 920 and the third lens 930.

The first lens 910 may have positive refractive power. An object-side surface of the first lens 910 may have a convex shape in the paraxial region, and an image-side surface of the first lens 910 may have a concave shape in the paraxial region. The first lens 910 may be formed of plastic. Additionally, the first lens 910 may be an aspherical lens. For example, the first lens 910 may be a double-sided aspherical lens in which both an object-side surface and an imaging-side surface thereof are aspherical.

The second lens 920 may have negative refractive power. An object-side surface of the second lens 920 may have a convex shape in the paraxial region, and an image-side surface of the second lens 920 may have a concave shape in the paraxial region. The second lens 920 may be formed of a plastic material. For example, the second lens 920 may be formed of a plastic material having different optical properties (e.g., different refractive index and Abbe number) from the first lens 910. Additionally, the second lens 920 may be an aspherical lens. For example, the second lens 920 may be a double-sided aspherical lens in which both an object-side surface and an imaging-side surface thereof are aspherical.

The third lens 930 may have negative refractive power. An object-side surface of the third lens 930 may have a convex shape in the paraxial region, and an image-side surface of the third lens 930 may have a concave shape in the paraxial region. The third lens 930 may be formed of a plastic material. For example, the third lens 930 may be formed of a plastic material having the same optical properties (e.g., the same refractive index and Abbe number) as the second lens 920. Additionally, the third lens 930 may be an aspherical lens. For example, the third lens 930 may be a double-sided aspherical lens in which both an object-side surface and an imaging-side surface thereof are aspherical.

The fourth lens 940 may have positive refractive power. An object-side surface of the fourth lens 940 may have a concave shape in the paraxial region, and an image-side surface of the fourth lens 940 may have a convex shape in the paraxial region. The fourth lens 940 may be formed of a plastic material. For example, the fourth lens 940 may be formed of a plastic material having different optical properties (e.g., different refractive index and Abbe number) from the third lens 930. At the same time, the fourth lens 940 may be formed of a plastic material having the same optical properties (e.g., the same refractive index and Abbe number) as the first lens 910. Additionally, the fourth lens 940 may be an aspherical lens. For example, the fourth lens 940 may be a double-sided aspherical lens in which both an object-side surface and an imaging-side surface thereof are aspherical.

The fifth lens 950 may have negative refractive power. An object-side surface of the fifth lens 950 may have a convex shape in the paraxial region, and an image-side surface of the fifth lens 950 may have a concave shape in the paraxial region. The fifth lens 950 may be formed of a plastic material. For example, the fifth lens 950 may be formed of a plastic material having different optical properties (e.g., different refractive index and Abbe number) from the fourth lens 940. Additionally, the fifth lens 950 may be an aspherical lens. For example, the fifth lens 950 may be a double-sided aspherical lens in which an object-side surface and an imaging-side surface thereof are aspherical.

The sixth lens 960 may have positive refractive power. An object-side surface of the sixth lens 960 may have a convex shape in the paraxial region, and an image-side surface of the sixth lens 960 may have a concave shape in the paraxial region. The sixth lens 960 may be formed of a plastic material. For example, the sixth lens 960 may be formed of a plastic material having different optical properties (e.g., different refractive index and Abbe number) from the fifth lens 950. Additionally, the sixth lens 960 may be an aspherical lens. For example, the sixth lens 960 may be a double-sided aspherical lens in which both an object-side surface and an imaging-side surface thereof are aspherical.

The seventh lens 970 may have a positive refractive power. Both an object-side surface and an imaging-side surface of the seventh lens 970 may have a convex shape in the paraxial region. The seventh lens 970 may be formed of a plastic material. For example, the seventh lens 970 may be formed of a plastic material having different optical properties (e.g., a different refractive index and Abbe number) from the sixth lens 960. Also, the seventh lens 970 may be an aspherical lens. For example, the seventh lens 970 may be a double-sided aspherical lens in which both an object-side surface and an imaging-side surface thereof are aspherical.

The eighth lens 980 may have negative refractive power. An object-side surface of the eighth lens 980 may have a convex shape in the paraxial region, and an image-side surface of the eighth lens 980 may have a concave shape in the paraxial region. The eighth lens 980 may be formed of a plastic material. For example, the eighth lens 980 may be formed of a plastic material having different optical properties (e.g., different refractive index and Abbe number) from the seventh lens 970. Additionally, the eighth lens 980 may be an aspherical lens. For example, the eighth lens 980 may be a double-sided aspherical lens in which both an object-side surface and an imaging-side surface thereof are aspherical.

Table 17 below illustrates optical and physical parameters of the optical imaging system 900 according to the ninth embodiment of the present disclosure.

| [0216] Table 17: | | | | |
|---|---|---|---|---|
| Surface | Radius of | Thickness/ | Refractive | Abbe |
| | Curvature | Distance | Index | number |
| Object | Infinity | Infinity | | |
| 1 | Infinity | -1.050 | | |
| 2 | 3.236 | 1.273 | 1.544 | 56.0 |
| 3 | 31.761 | 0.050 | | |
| 4 | 11.106 | 0.270 | 1.671 | 19.4 |
| 5 | 5.556 | 0.538 | | |
| 6 | Infinity | 0.000 | | |
| 7 | 10.412 | 0.230 | 1.671 | 19.4 |
| 8 | 9.974 | 0.254 | | |
| 9 | -26.171 | 0.684 | 1.544 | 56.0 |
| 10 | -9.133 | 0.052 | | |
| 11 | 11.395 | 0.258 | 1.651 | 21.5 |
| 12 | 6.988 | 0.459 | | |
| 13 | 18.109 | 0.650 | 1.567 | 37.4 |
| 14 | 18.566 | 0.468 | | |
| 15 | 4.036 | 1.020 | 1.544 | 56.0 |
| 16 | -14.142 | 0.666 | | |
| 17 | 15.933 | 0.480 | 1.535 | 55.7 |
| 18 | 2.044 | 0.463 | | |
| 19 | Infinity | 0.210 | 1.517 | 64.2 |
| 20 | Infinity | 0.611 | | |
| Image | Infinity | | | |

Table 18 below shows aspherical data of the optical imaging system 900 according to a ninth embodiment of the present disclosure.

TABLE 18

| Surface | 2 | 3 | 4 | 5 | 7 | 8 | 9 | 10 |
|---|---|---|---|---|---|---|---|---|
| K | −4.92E−01 | 2.54E+01 | 8.70E+00 | −8.94E+00 | −5.65E+01 | 1.04E+01 | −1.21E+01 | 1.25E+01 |
| A | 9.37E−03 | −1.08E−03 | −1.14E−03 | −9.92E−04 | −4.96E−03 | −6.22E−04 | −2.09E−02 | 6.16E−03 |
| B | −2.35E−02 | 1.36E−02 | −2.95E−02 | −7.94E−03 | −6.16E−03 | −4.54E−02 | 1.45E−01 | −3.93E−02 |
| C | 4.57E−02 | −2.28E−02 | 1.07E−01 | 3.49E−02 | −8.29E−03 | 1.32E−01 | −5.06E−01 | 7.26E−02 |
| D | −5.73E−02 | 2.51E−02 | −2.11E−01 | −7.76E−02 | 3.35E−02 | −2.71E−01 | 1.07E+00 | −9.38E−02 |
| E | 4.98E−02 | −2.00E−02 | 2.63E−01 | 1.08E−01 | −6.02E−02 | 3.77E−01 | −1.49E+00 | 9.28E−02 |
| F | −3.11E−02 | 1.17E−02 | −2.23E−01 | −1.04E−01 | 6.60E−02 | −3.65E−01 | 1.44E+00 | −7.01E−02 |
| G | 1.42E−02 | −5.00E−03 | 1.34E−01 | 7.16E−02 | −4.70E−02 | 2.51E−01 | −9.93E−01 | 3.93E−02 |
| H | −4.77E−03 | 1.57E−03 | −5.77E−02 | −3.66E−02 | 2.20E−02 | −1.25E−01 | 4.93E−01 | −1.59E−02 |
| J | 1.18E−03 | −3.56E−04 | 1.79E−02 | 1.38E−02 | −6.53E−03 | 4.46E−02 | −1.77E−01 | 4.58E−03 |
| L | −2. 12E−04 | 5.80E−05 | −3.99E−03 | −3.85E−03 | 1.06E−03 | −1.14E−02 | 4.52E−02 | −9.08E−04 |
| M | 2.69E−05 | −6.54E−06 | 6.19E−04 | 7.64E−04 | −2.40E−05 | 2.05E−03 | −8.07E−03 | 1.17E−04 |
| N | −2.27E−06 | 4.85E−07 | −6.36E−05 | −1.02E−04 | −2.42E−05 | −2.44E−04 | 9.51E−04 | −8.58E−06 |
| O | 1.15E−07 | −2.12E−08 | 3.89E−06 | 8.30E−06 | 4.19E−06 | 1.74E−05 | −6.66E−05 | 2.40E−07 |
| P | −2.63E−09 | 4.15E−10 | −1.07E−07 | −3.06E−07 | −2.32E−07 | −5.59E−07 | 2.10E−06 | 3.90E−09 |
| Surface | 11 | 12 | 13 | 14 | 15 | 16 | 17 | 18 |
| K | −4.29E+01 | −1.69E+01 | 0.00E+00 | 3.86E+01 | −1.29E+01 | −9.90E+01 | 6.96E+00 | −5.94E+00 |
| A | −1.34E−02 | −3.75E−03 | −2.59E−02 | −3.97E−02 | −7.43E−04 | 2.67E−03 | −1.25E−01 | −6.86E−02 |
| B | −3.65E−02 | −7.14E−02 | 3.14E−02 | −2.13E−02 | −7.18E−03 | −7.30E−03 | 3.88E−02 | 2.85E−02 |
| C | 3.80E−02 | 1.73E−01 | −5.55E−02 | 6.73E−02 | 5.48E−03 | 4.59E−03 | −6.51E−03 | −8.25E−03 |
| D | −1.16E−02 | −2.75E−01 | 7.57E−02 | −8.40E−02 | −2.73E−03 | −1.87E−03 | 3.67E−04 | 1.77E−03 |
| E | −1.14E−02 | 3.00E−01 | −7.25E−02 | 6.53E−02 | 9.29E−04 | 6.49E−04 | 1.26E−04 | −2.81E−04 |
| F | 1.36E−02 | −2.31E−01 | 4.86E−02 | −3.46E−02 | −2.21E−04 | −1.82E−04 | −4.13E−05 | 3.29E−05 |
| G | −5.31E−03 | 1.27E−01 | −2.31E−02 | 1.29E−02 | 3.56E−05 | 3.69E−05 | 6.49E−06 | −2.80E−06 |
| H | −2.74E−04 | −5.05E−02 | 7.91E−03 | −3.44E−03 | −3.79E−06 | −5.23E−06 | −6.52E−07 | 1.73E−07 |
| J | 1.19E−03 | 1.46E−02 | −1.95E−03 | 6.57E−04 | 2.61E−07 | 5.19E−07 | 4.48E−08 | −7.77E−09 |
| L | −5.67E−04 | −3.00E−03 | 3.43E−04 | −8.92E−05 | −1.08E−08 | −3.58E−08 | −2.14E−09 | 2.49E−10 |
| M | 1.43E−04 | 4.32E−04 | −4.18E−05 | 8.39E−06 | 2.12E−10 | 1.68E−09 | 6.96E−11 | −5.53E−12 |
| N | −2.12E−05 | −4.11E−05 | 3.36E−06 | −5.19E−07 | 1.39E−12 | −5.17E−11 | −1.48E−12 | 8.10E−14 |
| O | 1.74E−06 | 2.32E−06 | −1.60E−07 | 1.90E−08 | −1.45E−13 | 9.33E−13 | 1.86E−14 | −7.03E−16 |
| P | −6.15E−08 | −5.90E−08 | 3.40E−09 | −3.11E−10 | 1.96E−15 | −7.50E−15 | −1.04E−16 | 2.73E−18 |

### Tenth Embodiment

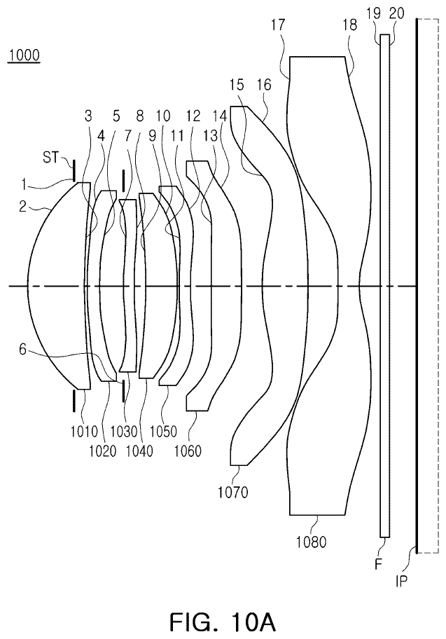

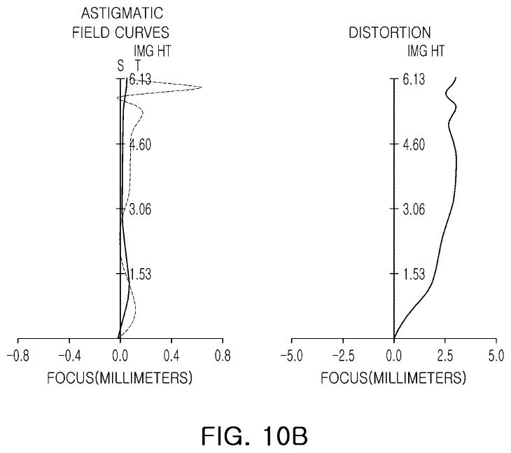

FIG. 10A is a configuration diagram of an optical imaging system according to a tenth embodiment of the present disclosure. FIG. 10B is a graph illustrating aberration characteristics of an optical imaging system according to the tenth embodiment of the present disclosure.

According to the tenth embodiment, the optical imaging system 1000 may include a first lens 1010, a second lens 1020, a third lens 1030, a fourth lens 1040, a fifth lens 1050, a sixth lens 1060, a seventh lens 1070, and an eighth lens 1080 arranged in order from the object side, and may further include an infrared blocking filter F and an image sensor (i.e., an image plane (IP)) disposed on an image side of the eighth lens 1080. Additionally, the optical imaging system 1000 may further include an aperture ST disposed between an object-side surface and an image-side surface of the first lens 1010. Furthermore, the optical imaging system 1000 may further include a spacer between the second lens 1020 and the third lens 1030.

The first lens 1010 may have positive refractive power. An object-side surface of the first lens 1010 may have a convex shape in the paraxial region, and an image-side surface of the first lens 1010 may have a concave shape in the paraxial region. The first lens 1010 may be formed of plastic. Additionally, the first lens 1010 may be an aspherical lens. For example, the first lens 1010 may be a double-sided aspherical lens in which both an object-side surface and an image-side surface thereof are aspherical.

The second lens 1020 may have negative refractive power. An object-side surface of the second lens 1020 may have a convex shape in the paraxial region, and an image-side surface of the second lens 1020 may have a concave shape in the paraxial region. The second lens 1020 may be formed of a plastic material. For example, the second lens 1020 may be formed of a plastic material having different optical properties (e.g., different refractive index and Abbe number) from the first lens 1010. Additionally, the second lens 1020 may be an aspherical lens. For example, the second lens 1020 may be a double-sided aspherical lens in which both an object-side surface and an image-side surface thereof are aspherical.

The third lens 1030 may have negative refractive power. An object-side surface of the third lens 1030 may have a convex shape in the paraxial region, and an image-side surface of the third lens 1030 may have a concave shape in the paraxial region. The third lens 1030 may be formed of a plastic material. For example, the third lens 1030 may be formed of a plastic material having the same optical properties (e.g., the same refractive index and Abbe number) as the second lens 1020. Additionally, the third lens 1030 may be an aspherical lens. For example, the third lens 1030 may be a double-sided aspherical lens in which both the object-side surface and the image-side surface are aspherical surfaces.

The fourth lens 1040 may have positive refractive power. An object-side surface of the fourth lens 1040 may have a concave shape in the paraxial region, and an image-side surface of the fourth lens 1040 may have a convex shape in the paraxial region. The fourth lens 1040 may be formed of a plastic material. For example, the fourth lens 1040 may be formed of a plastic material having different optical properties (e.g., different refractive index and Abbe number) from the third lens 1030. At the same time, the fourth lens 1040 may be formed of a plastic material having the same optical properties (e.g., the same refractive index and Abbe number) as the first lens 1010. Additionally, the fourth lens 1040 may be an aspherical lens. For example, the fourth lens 1040 may be a double-sided aspherical lens in which both an object-side surface and an image-side surface thereof are aspherical.

The fifth lens 1050 may have negative refractive power. An object-side surface of the fifth lens 1050 may have a convex shape in the paraxial region, and an image-side surface of the fifth lens 1050 may have a concave shape in the paraxial region. The fifth lens 1050 may be formed of a plastic material. For example, the fifth lens 1050 may be formed of a plastic material having different optical properties (e.g., different refractive index and Abbe number) from the fourth lens 1040. Also, the fifth lens 1050 may be an aspherical lens. For example, the fifth lens 1050 may be a double-sided aspherical lens in which both an object-side surface and an image-side surface thereof are aspherical.

The sixth lens 1060 may have positive refractive power. An object-side surface of the sixth lens 1060 may have a convex shape in the paraxial region, and an image-side surface of the sixth lens 1060 may have a concave shape in the paraxial region. The sixth lens 1060 may be formed of a plastic material. For example, the sixth lens 1060 may be formed of a plastic material having different optical properties (e.g., different refractive index and Abbe number) from the fifth lens 1050. Additionally, the sixth lens 1060 may be an aspherical lens. For example, the sixth lens 1060 may be a double-sided aspherical lens in which both an object-side surface and an image-side surface thereof are aspherical.

The seventh lens 1070 may have positive refractive power. Both an object-side surface and an image-side surface of the seventh lens 1070 thereof may have a convex shape in the paraxial region. The seventh lens 1070 may be formed of a plastic material. For example, the seventh lens 1070 may be formed of a plastic material having different optical properties (e.g., a different refractive index and Abbe number) from the sixth lens 1060. Additionally, the seventh lens 1070 may be an aspherical lens. For example, the seventh lens 1070 may be a double-sided aspherical lens in which both an object-side surface and an image-side surface thereof are aspherical.

The eighth lens 1080 may have negative refractive power. An object-side surface of the eighth lens 1080 may have a convex shape in the paraxial region, and an image-side surface of the eighth lens 1080 may have a concave shape in the paraxial region. An eighth lens 1080 may be formed of a plastic material. For example, the eighth lens 1080 may be formed of a plastic material having different optical properties (e.g., different refractive index and Abbe number) from the seventh lens 1070. Additionally, the eighth lens 1080 may be an aspherical lens. For example, the eighth lens 1080 may be a double-sided aspherical lens in which both an object-side surface and an image-side surface thereof are aspherical.

Table 19 below illustrates optical and physical parameters of the optical imaging system 1000 according to the tenth embodiment of the present disclosure.

TABLE 19

| | | | | |
|---|---|---|---|---|
| Surface | Radius of | Thickness/ | Refractive | Abbe |
| | Curvature | Distance | Index | number |
| Object | Infinity | Infinity | | |
| 1 | Infinity | -1.050 | | |
| 2 | 3.254 | 1.282 | 1.544 | 56.0 |
| 3 | 32.701 | 0.050 | | |
| 4 | 11.130 | 0.274 | 1.671 | 19.4 |
| 5 | 5.568 | 0.544 | | |
| 6 | Infinity | 0.000 | | |
| 7 | 10.317 | 0.230 | 1.671 | 19.4 |
| 8 | 9.797 | 0.259 | | |
| 9 | -26.864 | 0.691 | 1.544 | 56.0 |
| 10 | -9.117 | 0.050 | | |
| 11 | 11.150 | 0.250 | 1.651 | 21.5 |
| 12 | 6.862 | 0.458 | | |
| 13 | 17.797 | 0.678 | 1.567 | 37.4 |
| 14 | 18.631 | 0.460 | | |
| 15 | 4.063 | 1.020 | 1.544 | 56.0 |
| 16 | -13.674 | 0.664 | | |
| 17 | 15.948 | 0.480 | 1.535 | 55.7 |
| 18 | 2.044 | 0.463 | | |
| 19 | Infinity | 0.210 | 1.517 | 64.2 |
| 20 | Infinity | 0.614 | | |
| Image | Infinity | | | |

Table 20 below illustrates aspherical data of the optical imaging system 1000 according to the tenth embodiment of the present disclosure.

TABLE 20

| Surface | 2 | 3 | 4 | 5 | 7 | 8 | 9 | 10 |
|---|---|---|---|---|---|---|---|---|
| K | −4.93E−01 | 3.20E+01 | 8.59E+00 | −9.04E+00 | −5.75E+01 | 1.01E+01 | −4.76E+00 | 1.23E+01 |
| A | 9.68E−03 | −1.09E−03 | −1.17E−03 | −8.13E−04 | −4.62E−03 | −8.82E−4 | −2.21E−02 | 5.48E−03 |
| B | −2.43E−02 | 1.39E−02 | −2.79E−102 | −8.12E−03 | −6.48E−03 | −4.53E−02 | 1.47E−01 | −3.81E−02 |
| C | 4.67E−02 | −2.21E−02 | 1.03E−01 | 3.45E−0. | −7.97E−03 | 1.33E−01 | −5.00E−01 | 7.42E−02 |
| D | −5.80E−02 | 2.24E−02 | −2.03E−01 | −7.55E−02 | 3.30E−02 | −2.75E−01 | 1.04E+00 | −1.02E−01 |
| E | 4.99E−02 | −1.64E−02 | 2.53E−01 | 1.04E−01 | −5.94E−02 | 3.83E−01 | −1.43E+00 | 1.06E−01 |
| F | −3.08E−02 | 8.92E−03 | −2.14E−01 | −9.78E−02 | 6.52E−02 | −3.72E−01 | 1.37E+00 | −8.36E−02 |
| G | 1.39E−02 | −3.62E−03 | 1.27E−01 | 6.64E−02 | −4.65E−02 | 2.57E−01 | −9.31E−01 | 4.86E−02 |
| H | −4.62E−03 | 1.09E−03 | −5.46E−02 | −3.33E−02 | 2.19E−02 | −1.28E−01 | 4.56E−01 | −2.06E−02 |
| J | 1.13E−03 | −2.40E−04 | 1.69E−02 | 1.24E−02 | −6.61E−03 | 4.58E−02 | −1.62E−01 | 6.34E−03 |
| L | −2.00E−04 | 3.82E−05 | −3.72E−03 | −3.38E−03 | 1.13E−03 | −1.18E−02 | 4.08E−02 | −1.39E−03 |
| M | 2.50E−05 | −4.23E−06 | 5.73E−04 | 6.59E−04 | −5.19E−05 | 2.14E−03 | −7.18E−03 | 2.11E−04 |
| N | −2.09E−06 | 3.10E−07 | −5.83E−05 | −8.70E−05 | −1.82E−05 | −2.57E−04 | 8.35E−04 | −2.08E−05 |
| O | 1.04E−07 | −1.34E−08 | 3.54E−06 | 6.94E−06 | 3.51E−06 | 1.85E−05 | −5.76E−05 | 1.18E−06 |
| P | −2.34E−09 | 2.59E−10 | −9.65E−08 | −2.52E−07 | −1.99E−07 | −6.03E−07 | 1.79E−06 | −2.89E−08 |
| Surface | 11 | 12 | 13 | 14 | 15 | 16 | 17 | 18 |
| K | −3.92E+01 | −1.66E+01 | 0.00E+00 | 3.85E+01 | −1.25E+01 | −9.90E+01 | 6.98E+00 | −5.87E+00 |
| A | −1.40E−02 | −3.59E−03 | −2.41E−02 | −3.62E−02 | 5.25E−04 | 4.20E−03 | −1.22E−01 | −6.75E−02 |
| B | −3.49E−02 | −7.23E−02 | 2.71E−02 | −2.57E−02 | −8.76E−03 | −8.32E−03 | 3.65E−02 | 2.76E−02 |
| C | 3.67E−02 | 1.72E−01 | −4.57E−02 | 7.07E−02 | 6.75E−03 | 5.06E−03 | −5.64E−03 | −7.86E−03 |
| D | −1.11E−02 | −2.67E−01 | 5.92E−02 | −8.47E−02 | −3.40E−03 | −2.03E−03 | 1.57E−04 | 1.67E−03 |
| E | −1.13E−02 | 2.85E−01 | −5.38E−02 | 6.42E−02 | 1.18E−03 | 6.94E−04 | 1.59E−04 | −2.63E−04 |
| F | 1.35E−02 | −2.14E−01 | 3.40E−02 | −3.33E−02 | −2.87E−04 | −1.91E−04 | −4.46E−05 | 3.05E−05 |
| G | −5.49E−03 | 1.16E−01 | −1.53E−02 | 1.22E−02 | 4.80E−05 | 3.81E−05 | 6.66E−06 | −2.58E−06 |
| H | 7.26E−06 | −4.53E−02 | 4.93E−03 | −3.19E−03 | −5.50E−06 | −5.34E−06 | −6.50E−07 | 1.59E−07 |
| J | 1.00E−03 | 1.28E−02 | −1.14E−03 | 5.99E−04 | 4.30E−07 | 5.25E−07 | 4.37E−08 | −7.10E−09 |
| L | −4.96E−04 | −2.60E−03 | 1.89E−04 | −7.99E−05 | −2.28E−08 | −3.60E−08 | −2.05E−09 | 2.26E−10 |
| M | 1.26E−04 | 3.69E−04 | 1-2.16E−05 | 7.38E−06 | 7.98E−10 | 1.69E−09 | 6.58E−11 | −4.99E−12 |
| N | −1.86E−05 | −3.46E−05 | 1.62E−06 | −4.49E−07 | −1.75E−11 | −5.17E−11 | −1.38E−12 | 7.27E−14 |
| O | 1.52E−06 | 1.93E−06 | −7.11E−08 | 1.62E−08 | 2.12E−13 | 9.29E−13 | 1.72E−14 | −6.27E−16 |
| P | −5.31E−08 | −4.84E−08 | 1.38E−09 | −2.60E−10 | −1.05E−15 | −7.46E−15 | −9.52E−17 | 2.42E−18 |

### Eleventh Embodiment

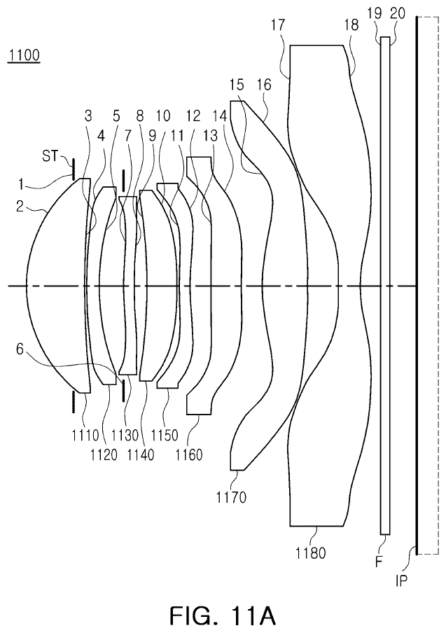

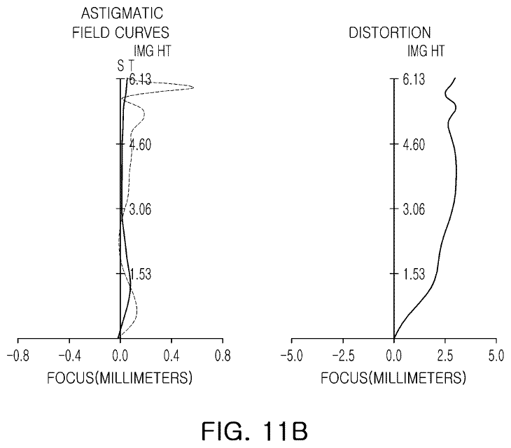

FIG. 11A is a configuration diagram of an optical imaging system according to an eleventh embodiment of the present disclosure. FIG. 11B is a graph illustrating aberration characteristics of an optical imaging system according to the eleventh embodiment of the present disclosure.

According to the eleventh embodiment, an optical imaging system 1100 may include a first lens 1110, a second lens 1120, a third lens 1130, a fourth lens 1140, a fifth lens 1150, a sixth lens 1160, a seventh lens 1170, and an eighth lens 1180 arranged in order from the object side, and may further include an infrared blocking filter F and an image sensor (an image plane (IP)) disposed on an image side of the eighth lens 1180. Additionally, the optical imaging system 1100 may further include an aperture ST disposed between an object-side surface and an image-side surface of the first lens 1110. Furthermore, the optical imaging system 1100 may further include a spacer between the second lens 1120 and the third lens 1130.

The first lens 1110 may have positive refractive power. An object-side surface of the first lens 1110 may have a convex shape in the paraxial region, and an image-side surface of the first lens 1110 may have a concave shape in the paraxial region. The first lens 1110 may be formed of a plastic material. Additionally, the first lens 1110 may be an aspherical lens. For example, the first lens 1110 may be a double-sided aspherical lens in which both an object-side surface and an image-side surface thereof are aspherical.

The second lens 1120 may have negative refractive power. An object-side surface of the second lens 1120 may have a convex shape in the paraxial region, and an image-side surface of the second lens 1120 may have a concave shape in the paraxial region. The second lens 1120 may be formed of a plastic material. For example, the second lens 1120 may be formed of a plastic material having different optical properties (e.g., different refractive index and Abbe number) from the first lens 1110. Additionally, the second lens 1120 may be an aspherical lens. For example, the second lens 1120 may be a double-sided aspherical lens in which both an object-side surface and an image-side surface thereof are aspherical.

The third lens 1130 may have negative refractive power. An object-side surface of the third lens 1130 may have a convex shape in the paraxial region, and an image-side surface of the third lens 1130 may have a concave shape in the paraxial region. The third lens 1130 may be formed of a plastic material. For example, the third lens 1130 may be formed of a plastic material having the same optical properties (e.g., the same refractive index and Abbe number) as the second lens 1120. Additionally, the third lens 1130 may be an aspherical lens. For example, the third lens 1130 may be a double-sided aspherical lens in which both an object-side surface and an image-side surface thereof are aspherical.

The fourth lens 1140 may have positive refractive power. An object-side surface of the fourth lens 1140 may have a concave shape in the paraxial region, and an image-side surface of the fourth lens 1140 may have a convex shape in the paraxial region. The fourth lens 1140 may be formed of a plastic material. For example, the fourth lens 1140 may be formed of a plastic material with different optical properties (e.g., different refractive index and Abbe number) from those of the third lens 1130. At the same time, the fourth lens 1140 may be formed of a plastic material having the same optical properties (e.g., the same refractive index and Abbe number) as the first lens 1110. Additionally, the fourth lens 1140 may be an aspherical lens. For example, the fourth lens 1140 may be a double-sided aspherical lens in which both an object-side surface and an image-side surface thereof are aspherical.

The fifth lens 1150 may have negative refractive power. An object-side surface of the fifth lens 1150 may have a convex shape in the paraxial region, and an image-side surface of the fifth lens 1150 may have a concave shape in the paraxial region. The fifth lens 1150 may be formed of a plastic material. For example, the fifth lens 1150 may be formed of a plastic material having different optical properties (e.g., different refractive index and Abbe number) from the fourth lens 1140. Additionally, the fifth lens 1150 may be an aspherical lens. For example, the fifth lens 1150 may be a double-sided aspherical lens in which both an object-side surface and an image-side surface thereof are aspherical.

The sixth lens 1160 may have positive refractive power. An object-side surface of the sixth lens 1160 may have a convex shape in the paraxial region, and an image-side surface of the sixth lens 1160 may have a concave shape in the paraxial region. The sixth lens 1160 may be formed of a plastic material. For example, the sixth lens 1160 may be formed of a plastic material having different optical properties (e.g., different refractive index and Abbe number) from the fifth lens 1150. Additionally, the sixth lens 1160 may be an aspherical lens. For example, the sixth lens 1160 may be a double-sided aspherical lens in which both an object-side surface and an image-side surface thereof are aspherical.

The seventh lens 1170 may have positive refractive power. Both an object-side surface and an image-side surface of the seventh lens 1170 may have a convex shape in a paraxial region. The seventh lens 1170 may be formed of a plastic material. For example, the seventh lens 1170 may be formed of a plastic material having different optical properties (e.g., different refractive index and Abbe number) from the sixth lens 1160. Additionally, the seventh lens 1170 may be an aspherical lens. For example, the seventh lens 1170 may be a double-sided aspherical lens in which both an object-side surface and an image-side surface thereof are aspherical.

The eighth lens 1180 may have negative refractive power. An object-side surface of the eighth lens 1180 may have a convex shape in the paraxial region, and an image-side surface of the eighth lens 1180 may have a concave shape in the paraxial region. The eighth lens 1180 may be formed of a plastic material. For example, the eighth lens 1180 may be formed of a plastic material having different optical properties (e.g., different refractive index and Abbe number) from the seventh lens 1170. Additionally, the eighth lens 1180 may be an aspherical lens. For example, the eighth lens 1180 may be a double-sided aspherical lens in which both an object-side surface and an image-side surface thereof are aspherical.

Table 21 below illustrates optical and physical parameters of the optical imaging system 1100 according to the eleventh embodiment of the present disclosure.

| [0244] Table 21: | | | | |
|---|---|---|---|---|
| Surface | Radius of | Thickness/ | Refractive | Abbe |
| | Curvature | Distance | Index | number |
| Object | Infinity | Infinity | | |
| 1 | Infinity | -1.050 | | |
| 2 | 3.268 | 1.293 | 1.544 | 56.0 |
| 3 | 33.428 | 0.050 | | |
| 4 | 11.186 | 0.277 | 1.671 | 19.4 |
| 5 | 5.581 | 0.550 | | |
| 6 | Infinity | 0.000 | | |
| 7 | 10.097 | 0.230 | 1.671 | 19.4 |
| 8 | 9.533 | 0.262 | | |
| 9 | -28.062 | 0.688 | 1.544 | 56.0 |
| 10 | -9.168 | 0.050 | | |
| 11 | 11.361 | 0.250 | 1.651 | 21.5 |
| 12 | 6.899 | 0.453 | | |
| 13 | 17.387 | 0.694 | 1.567 | 37.4 |
| 14 | 18.670 | 0.449 | | |
| 15 | 4.051 | 1.020 | 1.544 | 56.0 |
| 16 | -13.72 | 0.666 | | |
| 17 | 15.802 | 0.480 | 1.535 | 55.7 |
| 18 | 2.047 | 0.463 | | |
| 19 | Infinity | 0.210 | 1.517 | 64.2 |
| 20 | Infinity | 0.613 | | |
| Image | Infinity | | | |

Table 22 below illustrates aspherical data of the optical imaging system 1100 according to the eleventh embodiment of the present disclosure.

TABLE 22

| Surface | 2 | 3 | 4 | 5 | 7 | 8 | 9 | 10 |
|---|---|---|---|---|---|---|---|---|
| K | −4.95E−01 | 4.20E+01 | 8.14E+00 | −9.02E+00 | −5.35E+01 | 9.80E+00 | −8.06E+00 | 1.23E+01 |
| A | 1.03E−02 | −1.39E−03 | −1.35E−03 | −9.85E−04 | −4.67E−03 | −1.71E−03 | −2.33E−02 | 5.22E−03 |
| B | −2.55E−02 | 1.45E−02 | −2.61E−02 | −7.02E−03 | −6.52E−03 | −4.41E−02 | 1.50E−01 | −4.06E−02 |
| C | 4.81E−02 | −2.06E−02 | 9.97E−02 | 3.08E−02 | −7.82E−03 | 1.34E−01 | −5.08E−01 | 8.43E−02 |
| D | −5.89E−02 | 1.73E−02 | −2.00E−01 | −6.79E−02 | 3.28E−02 | −2.79E−01 | 1.05E+00 | −1.20E−01 |
| E | 5.02E−02 | −9.74E−03 | 2.51E−01 | 9.28E−02 | −5.90E−02 | 3.90E−01 | −1.45E+00 | 1.28E−01 |
| F | −3.07E−02 | 3.79E−03 | −2.13E−01 | −8.64E−02 | 6.47E−02 | −3.77E−01 | 1.38E+00 | −1.02E−01 |
| G | 1.38E−02 | −1.02E−03 | 1.27E−01 | 5.77E−02 | −4.62E−02 | 2.59E−01 | −9.32E−01 | 5.96E−02 |
| H | −4.54E−03 | 1.84E−04 | −5.43E−02 | −2.84E−02 | 2.18E−02 | −1.28E−01 | 4.54E−01 | −2.56E−02 |
| J | 1.10E−03 | −1.96E−05 | 1.67E−02 | 1.04E−02 | −6.64E−03 | 4.54E−02 | −1.60E−01 | 8.02E−03 |
| L | −1.93E−04 | 5.56E−07 | −3.69E−03 | −2.78E−03 | 1.17E−03 | −1.16E−02 | 4.00E−02 | −1.81E−03 |
| M | 2.39E−05 | 1.57E−07 | 5.65E−04 | 5.34E−04 | −6.56E−05 | 2.09E−03 | −6.98E−03 | 2.85E−04 |
| N | −1.97E−06 | −2.40E−08 | −5.73E−05 | −6.95E−05 | −1.53E−05 | −2.50E−04 | 8.03E−04 | −2.97E−05 |
| O | 9.69E−08 | 1.47E−09 | 3.46E−06 | 5.48E−06 | 3.17E−06 | 1.80E−05 | −5.48E−05 | 1.83E−06 |
| P | −2.16E−09 | −3.56E−11 | −9.38E−08 | −1.97E−07 | −1.83E−07 | −5.87E−07 | 1.68E−06 | −5.04E−08 |
| Surface | 11 | 12 | 13 | 14 | 15 | 6 | 17 | 18 |
| K | −3.87E+01 | −1.63E+01 | 0.00E+00 | 3.82E+01 | −1.24E+01 | −9.90E+01 | 6.91E+00 | −5.84E+00 |
| A | −1.42E−02 | −5.32E−04 | −2.43E−02 | −3.41E−02 | 1.91E−03 | 5.30E−03 | −1.21E−01 | −6.73E−02 |
| B | −3.57E−02 | −8.58E−02 | 3.66E−02 | −2.60E−02 | −9.65E−03 | −8.90E−03 | 3.51E−02 | 2.71E−02 |
| C | 3.84E−02 | 2.06E−01 | −7.28E−02 | 6.74E−02 | 7.05E−03 | 5.16E−03 | −5.00E−03 | −7.64E−03 |
| D | −1.22E−02 | −3.24E−01 | 1.01E−01 | −7.93E−02 | −3.41E−03 | −1.95E−03 | 1.66E−05 | 1.61E−03 |
| E | −1.10E−02 | 3.49E−01 | −9.56E−02 | 5.93E−02 | 1.13E−03 | 6.24E−04 | 1.71E−04 | −2.53E−04 |
| F | 1.34E−02 | −2.65E−01 | 6.24E−02 | −3.04E−02 | −2.64E−04 | −1.66E−04 | −4.34E−05 | 2.93E−05 |
| G | −5.34E−03 | 1.45E−01 | −2.88E−02 | 1.10E−02 | 4.26E−05 | 3.29E−05 | 6.20E−06 | −2.48E−06 |
| H | −1.80E−04 | −5.70E−02 | 9.54E−03 | −2.86E−03 | −4.73E−06 | −4.63E−06 | −5.88E−07 | 1.53E−07 |
| J | 1.12E−03 | 1.63E−02 | −2.28E−03 | 5.33E−04 | 3.59E−07 | 4.59E−07 | 3.88E−08 | −6.81E−09 |
| L | −5.40E−04 | −3.33E−03 | 3.88E−04 | −7.06E−05 | −1.85E−08 | −3.18E−08 | −1.79E−09 | 2.16E−10 |
| M | 1.36E−04 | 4.75E−04 | −4.58E−05 | 6.46E−06 | 6.34E−10 | 1.51E−09 | 5.68E−11 | −4.78E−12 |
| N | −2.02E−05 | −4.49E−05 | 3.57E−06 | −3.89E−07 | −1.38E−11 | −4.68E−11 | −1.18E−12 | 6.95E−14 |
| O | 1.66E−06 | 2.52E−06 | −1.64E−07 | 1.39E−08 | 1.71E−13 | 8.54E−13 | 1.45E−14 | −5.98E−16 |
| P | −5.85E−08 | −6.37E−08 | 3.39E−09 | −2.21E−10 | −9.37E−16 | −6.94E−15 | −7.98E−17 | 2.30E−18 |

### Twelfth Embodiment

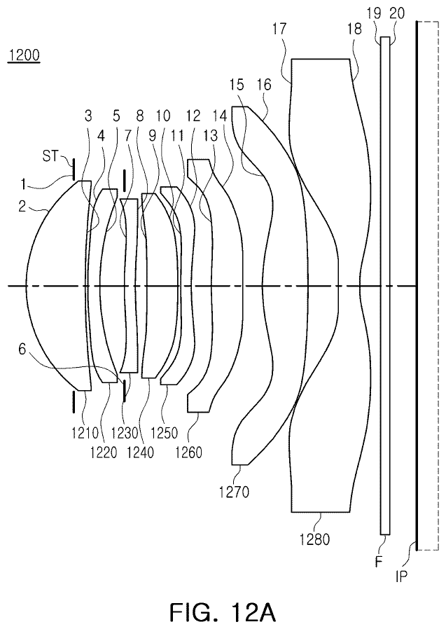

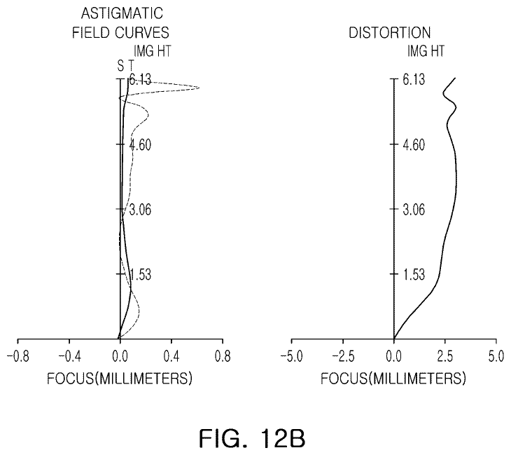

FIG. 12A is a configuration diagram of an optical imaging system according to a twelfth embodiment of the present disclosure. FIG. 12B is a graph illustrating aberration characteristics of an optical imaging system according to the twelfth embodiment of the present disclosure.

According to the twelfth embodiment, an optical imaging system 1200 may include a first lens 1210, a second lens 1220, a third lens 1230, a fourth lens 1240, a fifth lens 1250, a sixth lens 1260, a seventh lens 1270, and an eighth lens 1280 arranged in order from the object side, and may further include an infrared blocking filter F and an image sensor (i.e., an image plane (IP)) disposed on an image side of the eighth lens 1280. Additionally, the optical imaging system 1200 may further include an aperture ST disposed between an object-side surface and an image-side surface of the first lens 1210. Furthermore, the optical imaging system 1200 may further include a spacer between the second lens 1220 and the third lens 1230.

The first lens 1210 may have positive refractive power. An object-side surface of the first lens 1210 may have a convex shape in the paraxial region, and an image-side surface of the first lens 1210 may have a concave shape in the paraxial region. The first lens 1210 may be formed of plastic. Additionally, the first lens 1210 may be an aspherical lens. For example, the first lens 1210 may be a double-sided aspherical lens in which both an object-side surface and an image-side surface thereof are aspherical.

The second lens 1220 may have negative refractive power. An object-side surface of the second lens 1220 may have a convex shape in the paraxial region, and an image-side surface of the second lens 1220 may have a concave shape in the paraxial region. The second lens 1220 may be formed of a plastic material. For example, the second lens 1220 may be formed of a plastic material having different optical properties (e.g., different refractive index and Abbe number) from the first lens 1210. Additionally, the second lens 1220 may be an aspherical lens. For example, the second lens 1220 may be a double-sided aspherical lens in both object- and image-side surfaces.

A third lens 1230 may have negative refractive power. An object-side surface of the third lens 1230 may have a convex shape in the paraxial region, and an image-side surface of the third lens 1230 may have a concave shape in the paraxial region. The third lens 1230 may be formed of a plastic material. For example, the third lens 1230 may be formed of a plastic material having the same optical properties (e.g., the same refractive index and Abbe number) as the second lens 1220. Additionally, the third lens 1230 may be an aspherical lens. For example, the third lens 1230 may be a double-sided aspherical lens in which both an object-side surface and an image-side surface thereof are aspherical.

The fourth lens 1240 may have positive refractive power. An object-side surface of the fourth lens 1240 may have a concave shape in the paraxial region, and an image-side surface of the fourth lens 1240 may have a convex shape in the paraxial region. The fourth lens 1240 may be formed of a plastic material. For example, the fourth lens 1240 may be formed of a plastic material having different optical properties (e.g., different refractive index and Abbe number) from the third lens 1230. At the same time, the fourth lens 1240 may be formed of a plastic material having the same optical properties (e.g., the same refractive index and Abbe number) as the first lens 1210. Additionally, the fourth lens 1240 may be an aspherical lens. For example, the fourth lens 1240 may be a double-sided aspherical lens in which both an object-side surface and an image-side surface thereof are aspherical.

The fifth lens 1250 may have negative refractive power. An object-side surface of the fifth lens 1250 may have a convex shape in the paraxial region, and an image-side surface of the fifth lens 1250 may have a concave shape in the paraxial region. The fifth lens 1250 may be formed of a plastic material. For example, the fifth lens 1250 may be formed of a plastic material having different optical properties (e.g., different refractive index and Abbe number) from the fourth lens 1240. Additionally, the fifth lens 1250 may be an aspherical lens. For example, the fifth lens 1250 may be a double-sided aspherical lens in which both an object-side surface and an image-side surface thereof are aspherical.

The sixth lens 1260 may have positive refractive power. An object-side surface of the sixth lens 1260 may have a convex shape in the paraxial region, and an image-side surface of the sixth lens 1260 may have a concave shape in the paraxial region. The sixth lens 1260 may be formed of a plastic material. For example, the sixth lens 1260 may be formed of a plastic material with different optical properties (e.g., different refractive index and Abbe number) from those of the fifth lens 1250. Additionally, the sixth lens 1260 may be an aspherical lens. For example, the sixth lens 1260 may be a double-sided aspherical lens in which both an object-side surface and an image-side surface thereof are aspherical.

The seventh lens 1270 may have positive refractive power. Both an object-side surface and an image-side surface of the seventh lens 1270 may have a convex shape in the paraxial region. The seventh lens 1270 may be formed of a plastic material. For example, the seventh lens 1270 may be formed of a plastic material having different optical properties (e.g., a different refractive index and Abbe number) from the sixth lens 1260. Additionally, the seventh lens 1270 may be an aspherical lens. For example, the seventh lens 1270 may be a double-sided aspherical lens in which both an object-side surface and an image-side surface thereof are aspherical.

The eighth lens 1280 may have negative refractive power. An object-side surface of the eighth lens 1280 may have a convex shape in the paraxial region, and an image-side surface of the eighth lens 1280 may have a concave shape in the paraxial region. The eighth lens 1280 may be formed of a plastic material. For example, the eighth lens 1280 may be formed of a plastic material having different optical properties (e.g., different refractive index and Abbe number) from the seventh lens 1270. Additionally, the eighth lens 1280 may be an aspherical lens. For example, the eighth lens 1280 may be a double-sided aspherical lens having both an object-side surface and an image-side surface.

Table 23 below illustrates optical and physical parameters of the optical imaging system 1200 according to the twelfth embodiment of the present disclosure.

| [0258] Table 23: | | | | |
|---|---|---|---|---|
| Surface | Radius of | Thickness/ | Refractive | Abbe |
| | Curvature | Distance | Index | number |
| Object | Infinity | Infinity | | |
| 1 | Infinity | -1.050 | | |
| 2 | 3.280 | 1.306 | 1.544 | 56.0 |
| 3 | 34.049 | 0.050 | | |
| 4 | 11.174 | 0.280 | 1.671 | 19.4 |
| 5 | 5.564 | 0.050 | | |
| 6 | Infinity | 0.000 | | |
| 7 | 9.959 | 0.230 | 1.671 | 19.4 |
| 8 | 9.446 | 0.263 | | |
| 9 | -28.923 | 0.699 | 1.544 | 56.0 |
| 10 | -9.218 | 0.050 | | |
| 11 | 12.041 | 0.250 | 1.651 | 21.5 |
| 12 | 7.041 | 0.436 | | |
| 13 | 16.770 | 0.693 | 1.567 | 37.4 |
| 14 | 18.679 | 0.437 | | |
| 15 | 3.977 | 1.020 | 1.544 | 56.0 |
| 16 | -14.532 | 0.671 | | |
| 17 | 15.649 | 0.480 | 1.535 | 55.7 |
| 18 | 2.057 | 0.463 | | |
| 19 | Infinity | 0.210 | 1.517 | 64.2 |
| 20 | Infinity | 0.608 | | |
| Image | Infinity | | | |

Table 24 below illustrates aspherical data of the optical imaging system 1200 according to the twelfth embodiment of the present disclosure.

TABLE 24

| Surface | 2 | 3 | 4 | 5 | 7 | 8 | 9 | 10 |
|---|---|---|---|---|---|---|---|---|
| K | −5.03E−01 | 4.24E+01 | 8.07E+00 | −9.09E+00 | −5.35E+01 | 9.72E+00 | −1.72E+01 | 1.23E+01 |
| A | 1.03E−02 | −2.57E−03 | −1.42E−03 | −1.06E−03 | −4.49E−03 | −1.70E−03 | −2.15E−02 | 5.35E−03 |
| B | −2.54E−02 | 1.82E−02 | −2.60E−02 | −6.62E−03 | −6.52E−03 | −4.38E−02 | 1.40E−01 | −3.97E−02 |
| C | 4.76E−02 | −2.78E−02 | 9.92E−02 | 2.98E−02 | −7.58E−03 | 1.32E−01 | −4.66E−01 | 8.22E−02 |
| D | −5.81E−02 | 2.63E−02 | −1.98E−01 | −6.57E−02 | 3.18E−02 | −2.76E−01 | 9.45E−01 | −1.16E−01 |
| E | 4.93E−02 | −1.71E−02 | 2.48E−01 | −8.93E−02 | −5.70E−02 | 3.86E−01 | −1.27E+00 | 1.22E−01 |
| F | −3.00E−02 | 7.98E−03 | −2.10E−01 | −8.25E−02 | 6.23E−02 | −3.73E−01 | 1.17E+00 | −9.52E−02 |
| G | 1.33E−02 | −2.71E−03 | 1.25E−01 | 5.46E−02 | −4.43E−02 | 2.55E−01 | −7.72E−01 | 5.49E−02 |
| H | −4.37E−03 | 6.73E−04 | −5.33E−02 | −2.65E−02 | 2.09E−02 | −1.26E−01 | 3.65E−01 | −2.33E−02 |
| J | 1.05E−03 | −1.22E−04 | 1.64E−02 | 9.57E−03 | −6.35E−03 | 4.50E−02 | −1.24E−01 | 7.21E−03 |
| L | −1.83E−04 | 1.57E−05 | −3.59E−03 | −2.54E−03 | 1.13E−03 | −1.16E−02 | 3.00E−02 | −1.62E−03 |
| M | 2.25E−05 | −1.42E−06 | 5.49E−04 | 4.81E−04 | −7.00E−05 | 2.08E−03 | −5.02E−03 | 2.55E−04 |
| N | −1.83E−06 | 8.41E−08 | −5.55E−05 | −6.19E−05 | −1.27E−05 | −2.51E−04 | 5.52E−04 | −2.67E−05 |
| O | 8.95E−08 | −2.93E−09 | 3.33E−06 | 4.82E−06 | 2.77E−06 | 1.82E−05 | −3.58E−05 | 1.66E−06 |
| P | −1.97E−09 | 4.50E−11 | −8.98E−08 | −1.71E−07 | −1.61E−07 | −5.99E−07 | 1.04E−06 | −4.65E−08 |
| Surface | 11 | 12 | 13 | 14 | 15 | 16 | 17 | 18 |
| K | −4.07E+01 | −1.62E+01 | 0.00E+00 | 3.81E+01 | −1.19E+01 | −9.90E+01 | 6.90E+00 | −5.77E+00 |
| A | −1.44E−02 | 1.24E−03 | −2.48E−02 | −3.10E−02 | 2.84E−03 | 6.73E−03 | −1.20E−01 | −6.80E−02 |
| B | −3.53E−02 | −9.42E−02 | 4.36E−02 | −3.36E−02 | −1.05E−02 | −9.24E−03 | 3.29E−02 | 2.71E−02 |
| C | 3.82E−02 | 2.27E−01 | −9.04E−02 | 7.82E−02 | 7.25E−03 | 4.62E−03 | −3.59E−03 | −7.52E−03 |
| D | −1.22E−02 | −3.56E−01 | 1.26E−01 | −8.94E−02 | −3.23E−03 | −1.35E−03 | −4.53E−04 | 1.57E−03 |
| E | −1.09E−02 | 3.81E−01 | −1.18E−01 | 6.59E−02 | 9.78E−04 | 3.39E−04 | 2.68E−04 | −2.45E−04 |
| F | 1.33E−02 | −2.87E−01 | 7.61E−02 | −3.35E−02 | −2.08E−04 | −8.63E−05 | −5.67E−05 | 2.84E−05 |
| G | −5.31E−03 | 1.55E−01 | −3.48E−02 | 1.20E−02 | 3.02E−05 | 1.84E−05 | 7.45E−06 | −2.41E−06 |
| H | −1.73E−04 | −6.03E−02 | 1.14E−02 | −3.10E−03 | −2.88E−06 | −2.82E−06 | −6.70E−07 | 1.49E−07 |
| J | 1.11E−03 | 1.70E−02 | −2.70E−03 | 5.73E−04 | 1.69E−07 | 3.02E−07 | 4.24E−08 | −6.64E−09 |
| L | −5.35E−04 | −3.43E−03 | 4.54E−04 | −7.53E−05 | 5.00E−09 | −2.23E−08 | −1.90E−09 | 2.12E−10 |
| M | 1.35E−04 | 4.82E−04 | −5.30E−05 | 6.85E−06 | −2.36E−11 | 1.12E−09 | 5.86E−11 | −4.68E−12 |
| N | −2.00E−05 | −4.49E−05 | 4.08E−06 | −4.10E−07 | 7.14E−12 | −3.65E−11 | −1.19E−12 | 6.82E−14 |
| O | 1.65E−06 | 2.48E−06 | −1.85E−07 | 1.45E−08 | −2.20E−13 | 6.94E−13 | 1.43E−14 | −5.88E−16 |
| P | −5.82E−08 | −6.18E−08 | 3.77E−09 | −2.30E−10 | 2.32E−15 | −5.86E−15 | −7.75E−17 | 2.27E−18 |

### Thirteenth Embodiment

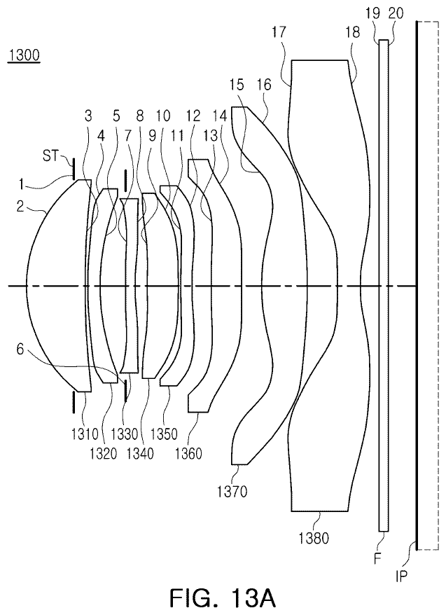

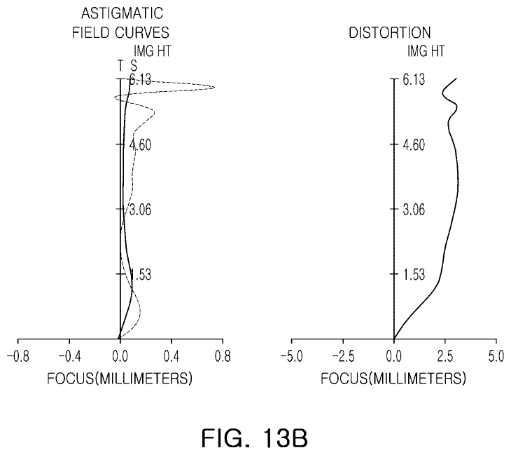

FIG. 13A is a configuration diagram of an optical imaging system according to a thirteenth embodiment of the present disclosure. FIG. 13B is a graph illustrating aberration characteristics of an optical imaging system according to the thirteenth embodiment of the present disclosure.

According to the thirteenth embodiment, an optical imaging system 1300 may include a first lens 1310, a second lens 1320, a third lens 1330, a fourth lens 1340, a fifth lens 1350, a sixth lens 1360, a seventh lens 1370, and an eighth lens 1380 arranged in order from the object side, and may further include an infrared blocking filter F and an image sensor (i.e., an image plane (IP)) disposed on an image side of the eighth lens 1380. Additionally, the optical imaging system 1300 may further include an aperture ST disposed between an object-side surface and an image-side surface of the first lens 1310. Furthermore, the optical imaging system 1300 may further include a spacer between the second lens 1320 and the third lens 1330.

The first lens 1310 may have positive refractive power. An object-side surface of the first lens 1310 may have a convex shape in the paraxial region, and an image-side surface of the first lens 1310 may have a concave shape in the paraxial region. The first lens 1310 may be formed of a plastic material. Additionally, the first lens 1310 may be an aspherical lens. For example, the first lens 1310 may be a double-sided aspherical lens in which both an object-side surface and an image-side surface thereof are aspherical.

The second lens 1320 may have negative refractive power. An object-side surface of the second lens 1320 may have a convex shape in the paraxial region, and an image-side surface of the second lens 1320 may have a concave shape in a paraxial region. The second lens 1320 may be formed of a plastic material. For example, the second lens 1320 may be formed of a plastic material having different optical characteristics (e.g., different refractive index and Abbe number) from the first lens 1310. Additionally, the second lens 1320 may be an aspherical lens. For example, the second lens 1320 may be a double-sided aspherical lens in which both an object-side surface and an image-side surface are aspherical.

The third lens 1330 may have negative refractive power. An object-side surface of the third lens 1330 may have a convex shape in the paraxial region, and an image-side surface of the third lens 1330 may have a concave shape in the paraxial region. The third lens 1330 may be formed of a plastic material. For example, the third lens 1330 may be formed of a plastic material having the same optical characteristics (e.g., the same refractive index and Abbe number) as the second lens 1320. Additionally, the third lens 1330 may be an aspherical lens. For example, the third lens 1330 may be a double-sided aspherical lens in which both an object-side surface and an image-side surface thereof are aspherical.

The fourth lens 1340 may have positive refractive power. An object-side surface of the fourth lens 1340 may have a concave shape in the paraxial region, and an image-side surface of the fourth lens 1340 may have a convex shape in the paraxial region. The fourth lens 1340 may be formed of a plastic material. For example, the fourth lens 1340 may be formed of a plastic material having different optical characteristics (e.g., different refractive index and Abbe number) from the third lens 1330. At the same time, the fourth lens 1340 may be formed of a plastic material having the same optical characteristics (e.g., the same refractive index and Abbe number) as the first lens 1310. Additionally, the fourth lens 1340 may be an aspherical lens. For example, the fourth lens 1340 may be a double-sided aspherical lens in which both an object-side surface and an image-side surface thereof are aspherical.

The fifth lens 1350 may have negative refractive power. An object-side surface of the fifth lens 1350 may have a convex shape in the paraxial region, and an image-side surface of the fifth lens 1350 may have a concave shape in the paraxial region. The fifth lens 1350 may be formed of a plastic material. For example, the fifth lens 1350 may be formed of a plastic material having different optical characteristics (e.g., different refractive index and Abbe number) from the fourth lens 1340. Additionally, the fifth lens 1350 may be an aspherical lens. For example, the fifth lens 1350 may be a double-sided aspherical lens in which both an object-side surface and an image-side surface thereof are aspherical.

The sixth lens 1360 may have positive refractive power. An object-side surface of the sixth lens 1360 may have a convex shape in the paraxial region, and an image-side surface of the sixth lens 1360 may have a concave shape in the paraxial region. The sixth lens 1360 may be formed of a plastic material. For example, the sixth lens 1360 may be formed of a plastic material having different optical characteristics (e.g., different refractive index and Abbe number) from the fifth lens 1350. Additionally, the sixth lens 1360 may be an aspherical lens. For example, the sixth lens 1360 may be a double-sided aspherical lens in which both an object-side surface and an image-side surface thereof are aspherical.

The seventh lens 1370 may have positive refractive power. Both an object-side surface and an image-side surface of the seventh lens 1370 may have a convex shape in the paraxial region. The seventh lens 1370 may be formed of a plastic material. For example, the seventh lens 1370 may be formed of a plastic material with optical characteristics (e.g., a different refractive index and Abbe number) that are different from the sixth lens 1360. Additionally, the seventh lens 1370 may be an aspherical lens. For example, the seventh lens 1370 may be a double-sided aspherical lens in which both an object-side surface and an image-side surface thereof are aspherical.

The eighth lens 1380 may have negative refractive power. An object-side surface of the eighth lens 1380 may have a convex shape in the paraxial region, and an image-side surface of the eighth lens 1380 may have a concave shape in the paraxial region. The eighth lens 1380 may be formed of a plastic material. For example, the eighth lens 1380 may be formed of a plastic material having different optical characteristics (e.g., different refractive index and Abbe number) from the seventh lens 1370. Additionally, the eighth lens 1380 may be an aspherical lens. For example, the eighth lens 1380 may be a double-sided aspherical lens in which both an object-side surface and an image-side surface thereof are aspherical.

Table 25 below illustrates optical and physical parameters of the optical imaging system 1300 according to the thirteenth embodiment of the present disclosure.

| [0272] Table 25: | | | | |
|---|---|---|---|---|
| Surface | Radius of | Thickness/ | Refractive | Abbe |
| | Curvature | Distance | Index | number |
| Object | Infinity | Infinity | | |
| 1 | Infinity | -1.050 | | |
| 2 | 3.282 | 1.311 | 1.544 | 56.0 |
| 3 | 34.683 | 0.050 | | |
| 4 | 11.248 | 0.280 | 1.671 | 19.4 |
| 5 | 5.574 | 0.552 | | |
| 6 | Infinity | 0.000 | | |
| 7 | 9.921 | 0.230 | 1.671 | 19.4 |
| 8 | 9.432 | 0.264 | | |
| 9 | -28.902 | 0.694 | 1.544 | 56.0 |
| 10 | -9.247 | 0.050 | | |
| 11 | 11.953 | 0.250 | 1.651 | 21.5 |
| 12 | 7.005 | 0.427 | | |
| 13 | 16.696 | 0.687 | 1.567 | 37.4 |
| 14 | 18.682 | 0.431 | | |
| 15 | 3.961 | 1.020 | 1.544 | 56.0 |
| 16 | -14.714 | 0.674 | | |
| 17 | 15.625 | 0.480 | 1.535 | 55.7 |
| 18 | 2.070 | 0.448 | | |
| 19 | Infinity | 0.210 | 1.517 | 64.2 |
| 20 | Infinity | 0.618 | | |
| Image | Infinity | | | |

Table 26 below shows aspherical data of the optical imaging system 1300 according to the thirteenth embodiment of the present disclosure.

TABLE 26

| Surface | 2 | 3 | 4 | 5 | 7 | 8 | 9 | 10 |
|---|---|---|---|---|---|---|---|---|
| K | −5.10E−01 | 4.27E+01 | 8.24E+00 | −9.11E+00 | −5.22E+01 | 9.72E+00 | −2.11E+01 | 1.23E+01 |
| A | 1.01E−02 | −2.38E−03 | −1.26E−03 | −1.09E−03 | −4.46E−03 | −1.87E−03 | −2.13E−02 | 5.54E−03 |
| B | −2.52E−02 | 1.65E−02 | −2.61E−02 | −6.56E−03 | −6.52E−03 | −4.35E−02 | 1.39E−01 | −3.98E−02 |
| C | 4.74E−02 | −2.29E−02 | 9.88E−02 | 2.97E−02 | −7.54E−03 | 1.32E−01 | −4.65E−01 | 8.21E−02 |
| D | −5.78E−02 | 1.87E−02 | −1.97E−01 | −6.53E−02 | 3.16E−02 | −2.76E−01 | 9.41E−01 | −1.16E−01 |
| E | 4.90E−02 | −9.92E−03 | 2.46E−01 | 8.87E−02 | −5.67E−02 | 3.86E−01 | −1.26E+00 | 1.21E−01 |
| F | −2.98E−02 | 3.54E−03 | −2.08E−01 | −8.18E−02 | 6.19E−02 | −3.73E−01 | 1.17E+00 | −9.47E−02 |
| G | 1.32E−02 | −8.35E−04 | 1.24E−01 | 5.40E−02 | −4.40E−02 | 2.56E−01 | −7.68E−01 | 5.45E−02 |
| H | −4.33E−03 | 1.21E−04 | −5.27E−02 | −2.62E−02 | 2.07E−02 | −1.26E−01 | 3.63E−01 | −2.30E−02 |
| J | 1.04E−03 | −7.80E−06 | 1.62E−02 | 9.42E−03 | −6.29E−03 | 4.51E−02 | −1.23E−01 | 7.13E−03 |
| L | −1.81E−04 | −6.06E−07 | −3.54E−03 | −2.49E−03 | 1.11E−03 | −1.16E−02 | 2.98E−02 | −1.59E−03 |
| M | 2.22E−05 | 1.78E−07 | 5.41E−04 | 4.72E−04 | −6.89E−05 | 2.09E−03 | −4.98E−03 | 2.50E−04 |
| N | −1.81E−06 | −1.66E−08 | −5.46E−05 | −6.05E−05 | −1.26E−05 | −2.52E−04 | 5.48E−04 | −2.61E−05 |
| O | 8.83E−08 | 7.47E−10 | 3.27E−06 | 4.71E−06 | 2.74E−06 | 1.83E−05 | −3.55E−05 | 1.62E−06 |
| P | −1.94E−09 | −1.36E−11 | −8.83E−08 | −1.67E−07 | −1.59E−07 | −6.03E−07 | 1.03E−06 | −4.50E−08 |
| Surface | 11 | 12 | 13 | 14 | 15 | 16 | 17 | 18 |
| K | −4.09E+01 | −1.62E+01 | 0.00E+00 | 3.81E+01 | −1.18E+01 | −9.90E+01 | 6.93E+00 | −5.80E+00 |
| A | −1.45E−02 | 1.53E−03 | −2.35E−02 | −2.97E−02 | 3.32E−03 | 6.06E−033 | −1.21E−01 | −6.81E−02 |
| B | −3.53E−02 | −9.48E−02 | 3.77E−02 | −3.73E−02 | −1.12E−02 | −8.23E−03 | 3.32E−02 | 2.71E−02 |
| C | 3.82E−02 | 2.26E−01 | −7.52E−02 | 8.35E−02 | 7.73E−03 | 3.84E−03 | −3.78E−03 | −7.50E−03 |
| D | −1.22E−02 | −3.52E−01 | 1.02E−01 | −9.45E−02 | −3.46E−03 | −9.74E−04 | −3.60E−04 | 1.57E−03 |
| E | −1.09E−02 | 3.74E−01 | −9.35E−02 | 6.94E−02 | 1.05E−03 | 2.20E−04 | 2.39E−04 | −2.47E−04 |
| F | 1.33E−02 | −2.80E−01 | 5.94E−02 | −3.52E−02 | −2.23E−04 | −6.09E−05 | −5.06E−05 | 2.88E−05 |
| G | −5.32E−03 | 1.50E−01 | −2.67E−02 | 1.27E−02 | 3.25E−05 | 1.46E−05 | 6.62E−06 | −2.46E−06 |
| H | −1.66E−04 | −5.83E−02 | 8.64E−03 | −3.27E−03 | −3.12E−06 | −2.42E−06 | −5.91E−07 | 1.52E−07 |
| J | 1.11E−03 | 1.64E−02 | −2.01E−03 | 6.06E−04 | 1.88E−07 | 2.72E−07 | 3.72E−08 | −6.85E−09 |
| L | −5.34E−04 | −3.29E−03 | 3.34E−04 | −7.98E−05 | −5.92E−09 | −2.08E−08 | −1.65E−09 | 2.19E−10 |
| M | 1.35E−04 | 4.62E−04 | −3.86E−05 | 7.29E−06 | 5.80E−12 | 1.06E−09 | 5.06E−11 | −4.86E−12 |
| N | −2.00E−05 | −4.29E−05 | 2.93E−06 | −4.37E−07 | 6.62E−12 | −3.52E−11 | −1.02E−12 | 7.11E−14 |
| O | 1.64E−06 | 2.37E−06 | −1.31E−07 | 1.55E−08 | −2.16E−13 | 6.77E−13 | 1.22E−14 | −6.14E−16 |
| P | −5.81E−08 | −5.89E−08 | 2.62E−09 | −2.47E−10 | 2.34E−15 | −5.77E−15 | −6.56E−17 | 2.37E−18 |

Table 27 below illustrates optical and physical parameters related to a focal length and a conditional expression of the optical imaging system according to embodiments of the present disclosure.

TABLE 27

| | Embodiment 1 | Embodiment 2 | Embodiment 3 | Embodiment 4 | Embodiment 5 | Embodiment 6 | Embodiment 7 |
|---|---|---|---|---|---|---|---|
| f | 6.864 | 6.622 | 6.554 | 6.565 | 6.575 | 6.537 | 6.535 |
| f1 | 6.262 | 6.397 | 6.294 | 6.381 | 6.335 | 6.368 | 6.375 |
| f2 | −16.956 | −17.433 | −15.772 | −16.403 | −16.056 | −16.180 | −16.032 |
| f3 | −47.158 | −463.622 | 641.235 | 534.159 | −1292.790 | −2260.607 | 6931.344 |
| f4 | 33.316 | 25.851 | 26.769 | 27.626 | 26.071 | 26.262 | 26.268 |
| f5 | −85.967 | −31.414 | −32.651 | −33.418 | −32.676 | −30.649 | −30.179 |
| f6 | 991.414 | −160.816 | −177.045 | −175.562 | −226.060 | −455.495 | −635.056 |
| f7 | 7.878 | 5.990 | 5.967 | 5.943 | 5.956 | 5.940 | 5.937 |
| f8 | −5.292 | −4.362 | −4.4420 | −4.379 | −4.371 | −4.410 | −4.426 |
| TTL | 8.440 | 8.440 | 8.430 | 8.440 | 8.441 | 8.455 | 8.490 |
| BFL | 1.245 | 1.282 | 1.285 | 1.285 | 1.284 | 1.277 | 1.269 |
| Fno | 1.449 | 1.450 | 1.430 | 1.435 | 1.437 | 1.412 | 1.379 |
| IMGHT | 6.13 | 6.13 | 6.13 | 6.13 | 6.13 | 6.13 | 6.13 |
| FOV | 82.000 | 83.748 | 84.345 | 84.248 | 84.166 | 84.451 | 84.415 |

| | Embodiment 8 | Embodiment 9 | Embodiment 10 | Embodiment 11 | Embodiment 12 | Embodiment 13 |
|---|---|---|---|---|---|---|
| f | 6.568 | 6.586 | 6.604 | 6.599 | 6.565 | 6.538 |
| f1 | 6.438 | 6.499 | 6.521 | 6.538 | 6.551 | 6.545 |
| f2 | −16.387 | −16.753 | −16.796 | −16.785 | −16.708 | −16.653 |
| f3 | −10391.75 | −444.370 | −349.836 | −301.359 | −330.451 | −348.581 |
| f4 | 26.370 | 25.342 | 24.944 | 24.631 | 24.484 | 24.608 |
| f5 | −28.655 | −28.211 | −27.860 | −27.398 | −26.382 | −26.329 |
| f6 | 10072.119 | 852.501 | 538.297 | 371.130 | 254.317 | 244.837 |
| f7 | 5.895 | 5.869 | 5.858 | 5.849 | 5.834 | 5.831 |
| f8 | −4.414 | −4.422 | −4.421 | −4.436 | −4.468 | −4.502 |
| TTL | 8.576 | 8.636 | 8.679 | 8.697 | 8.696 | 8.678 |
| BFL | 1.275 | 1.284 | 1.287 | 1.286 | 1.281 | 1.276 |
| Fno | 1.373 | 1.364 | 1.359 | 1.347 | 1.328 | 1.317 |
| IMGHT | 6.13 | 6.13 | 6.13 | 6.13 | 6.13 | 6.13 |
| FOV | 84.227 | 84.066 | 83.904 | 83.946 | 84.237 | 84.476 |

The optical imaging system, according to example embodiments of the present disclosure described above, may be manufactured to be slimmer than the size of the image sensor.

An aspect of the present disclosure is to provide an optical imaging system having a shorter total track length than a size of an image sensor. At the same time, an object of the present disclosure is to provide a bright optical imaging system.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens, a second lens, a third lens, a fourth lens having a concave object-side surface and a convex image-side surface, a fifth lens, a sixth lens, a seventh lens, and an eighth lens arranged in order from an object-side to an image plane,
wherein {TTL/(2*IMG HT)}*Fno<1.000 is satisfied,
where TTL is a distance on an optical axis from an object-side surface of the first lens to the image plane, IMG HT is a distance half of a diagonal length of the image plane, and Fno is an F value of the optical imaging system.

2. The optical imaging system of claim 1,
wherein the third lens has positive refractive power.

3. The optical imaging system of claim 1,
wherein the sixth lens has positive refractive power.

4. The optical imaging system of claim 1,
wherein 0<v1−(v6+v7)/2<30.00 is satisfied,
where v1 is an Abbe number of the first lens, v6 is an Abbe number of the sixth lens, and v7 is an Abbe number of the seventh lens.

5. The optical imaging system of claim 1,
wherein 0<f7/f<2.000 is satisfied,
where f is a focal length of the optical imaging system, and f7 is a focal length of the seventh lens.

6. The optical imaging system of claim 1,
wherein −1.000<f8/f<0 is satisfied,
where f is a focal length of the optical imaging system, and f8 is a focal length of the eighth lens.

7. The optical imaging system of claim 1,
wherein the third lens has negative refractive power.

8. The optical imaging system of claim 1,
wherein Abbe numbers of the first lens and the fourth lens are identical to each other.

9. The optical imaging system of claim 1,
wherein the seventh lens has a convex shape on an object-side surface and an image-side surface.

10. An optical imaging system, comprising:
a first lens, a second lens, a third lens, a fourth lens, a fifth lens, a sixth lens, a seventh lens, and an eighth lens arranged in order from an object side toward an image plane,
wherein 0.500≤TTL/(2*IMG HT)<0.750 and 1.000<Fno<1.600 are satisfied,
where TTL is a distance on an optical axis from an object-side surface of the first lens to the image plane, IMG HT is a distance half of a diagonal length of the image plane, and Fno is an F value of the optical imaging system.

11. The optical imaging system of claim 10,
wherein Abbe numbers of the second lens and the third lens are identical to each other.

12. The optical imaging system of claim 10,
wherein the seventh lens has positive refractive power and a convex image-side surface.

13. The optical imaging system of claim 10,
wherein the third lens has negative refractive power, and the sixth lens has positive refractive power.

14. The optical imaging system of claim 10,
wherein 1.100≤TTL/f≤1.400 is satisfied,
where f is a focal length of the optical imaging system.

15. The optical imaging system of claim 10,
wherein Abbe numbers of the first lens and the fourth lens are identical to each other.

16. The optical imaging system of claim 10,
wherein {TTL/(2*IMG HT)}*Fno<1.000 is satisfied.
